(19) United States
(12) Patent Application Publication
(10) Pub. No.: US 2008/0090169 A1
(43) Pub. Date: Apr. 17, 2008

(54) Composite Film Suitable as a Donor Support in a Radiation-Induced Thermal Transfer Imaging Process

(75) Inventors: Robert Eveson, Yarm (GB); Moira Logan, Stockton-on-Tees (GB); Christopher Ferguson, Hartlepoll (GB); Thomas Felder, Kennett Square, PA (US); James R. Joiner, Huddleston, VA (US); Richard Paul Pankratz, Circleville, OH (US)

Correspondence Address: RATNERPRESTIA, P.O. BOX 1596, WILMINGTON, DE, 19899, US

(73) Assignee: DUPONT TEIJIN FILMS U.S. LIMITED PARTNERSHIP, Wilmington (DE)

(21) Appl. No.: 11/665,900

(22) PCT Filed: Oct. 20, 2005
(86) PCT No.: PCT/GB05/04055

§ 371 Date: Nov. 15, 2007

(30) Foreign Application Priority Data
Oct. 20, 2004 (GB) 0423297.1

(51) Int. Cl. G03C 1/73; B28B 11/06

(52) U.S. Cl. 430/200; 264/131

(57) ABSTRACT

A composite film suitable as a donor support in a radiation-induced thermal transfer imaging process, said film comprising a polymeric substrate and a transfer-assist coating layer derived from an aqueous composition comprising one or more water-soluble or water-dispersible radiation-absorbing compound(s).

This invention relates to methods for radiation-induced thermal transfer of layers from a donor element to a receptor. The invention particularly relates to a thermal transfer donor support comprising a substrate and a functional coating on a surface thereof, to a method for its manufacture, and also to the functional coating composition itself. The invention is suitable for use in the preparation of a range of patterned coatings on a variety of receptor surfaces, which can find application in a number of end-uses. In particular, the invention is applicable to the preparation of a colour filter suitable for use in liquid crystal display devices. The invention is also suitable for use in the preparation of a patterned coating on the donor element.

The thermal transfer of materials in a predetermined pattern image (hereinafter referred to as “pattern-wise” or “image-wise”) from donor sheets to receptor substrates has been proposed for a variety of applications. For example, selective thermal transfer of materials such as inks (including conductive inks) may be used in the printing of graphics and circuitry; in photographic applications; and in applications currently served by ink-jet technology. In addition, thermal transfer may be utilised to form elements useful in electronic displays and other devices. Specifically, selective thermal transfer of colour filters, spacers, polarizers, conductive layers, transistors, phosphors and organic electroluminescent materials have all been proposed. Colour filters as components in a liquid crystal display (LCD) are of particular interest. The colour filter is a thin ink layer which controls the colour of a pixel in the LCD. A colour LCD must have at least three subpixels with red, green and blue colour filters to create each colour pixel. Through the control and variation of the voltage applied to the liquid crystal which control light transmission, the intensity of each subpixel can range over 256 shades. Combining the subpixels produces a possible palette of 16.8 million colours (256 shades of red; 256 shades of green; and 256 shades of blue). A general description of colour filters for LCDs is given by C. C. O'Mara in Liquid Crystal Flat Panel Display: Manufacturing Science and Technology, (Van Norstrand Reinhold, 1993, p70).

The current commercial manufacture of colour filters utilises photolithography, which involves a lengthy series of discrete process steps, as described in for instance W. J Latham and D. W. Hawley in Solid State Technology, May 1998. In the application of a single pigment, the substrate (typically glass) must first be prepared, then coated with the photoactive ink which is then dried, exposed, washed and then dried again. This procedure is repeated for each pigment. It would be desirable to reduce the number of process steps for purposes of economy efficiency, and in order to increase manufacturing flexibility. The present invention considers radiation-induced thermal imaging as an alternative and simpler manufacturing process. Radiation-induced thermal transfer imaging for the manufacture of colour filters is also addressed in U.S. Pat. No. 5,521,035. Other disclosures of thermal transfer donor elements include U.S. Pat. No. 6,689,538, U.S. Pat. No. 6,645,681, U.S. Pat. No. 6,482,564, U.S. Pat. No. 6,461,775, U.S. Pat. No. 6,358,664, U.S. Pat. No. 6,242,152, U.S. Pat. No. 6,051,318, U.S. Pat. No. 5,453,326, U.S. Pat. No. 5,387,496 and U.S. Pat. No. 5,350,732, and known coated support films are disclosed in U.S. Pat. No. 5,882,800, U.S. Pat. No. 5,453,326, U.S. Pat. No. 4,695,288 and U.S. Pat. No. 4,737,486.

In the thermal transfer printing process, inks are transferred from a donor sheet (typically comprising a polymeric support) to a receptor substrate (typically glass) by the application of heat in loci corresponding to the desired pattern or image. The donor sheet is exposed to electromagnetic radiation at one or more wavelengths (typically infrared radiation, usually near-infrared radiation, and preferably between about 780 and about 1200 nm) that is absorbed by a “light-to-heat converter” present in or on the donor sheet, the heat energy generated thereby then facilitating the ink transfer. The donor element can be exposed to the imaging radiation through the donor sheet. The transfer of material can occur via a variety of mechanisms, including sublimation transfer, diffusion transfer, mass transfer, ablative mass transfer and melt transfer. (As used herein, the term “light-to-heat converter” refers to a compound which absorbs the radiation utilised in the thermal transfer process to induce the transfer of material(s) from a donor sheet to a receptor sheet, by converting this radiation energy into heat energy. Similarly, the term “light-to-heat conversion” refers to a process in which the radiation utilised in the thermal transfer process to induce the transfer of material(s) from a donor sheet to a receptor sheet is absorbed and then converted to heat energy.) Typically, ink transfer is conducted in successive steps, and normally in a specific sequence, to form a red/green/blue pattern or image coating on the receptor sheet in the desired pattern or image. In the imaging process, the surface of the ink-coated donor sheet is typically in contact with the surface of the receiver sheet (as shown in FIG. 1). Alternatively, imaging can be effected via gap transfer in which the receptor and ink-coated donor sheets are separated by an ink-impermeable mask (also known as a black matrix) which masks specific areas of the receiver sheet (as shown in FIG. 2).

The transfer of some materials can be problematic. It is desirable to effect complete transfer of the ink, i.e. 100% transfer or as close as possible thereto, with no concomitant thermal degradation of the materials transferred. It is also desirable that the variability in the amount of ink transferred be very low. In other words, a system in which 95% of the ink is consistently transferred with a variability of ±0.5% is preferable to a system in which the amount of ink transferred varies between, for example, 97 and 100%. In addition, the resolution of the transferred image or pattern should be high with good line edge quality (i.e. smooth and sharp image edges). In order to promote good transfer, one or more additional layer(s) can be deposited on the donor sheet substrate prior to application of the ink or transfer layer. These additional layers have been variously referred to in the prior art as light-to-heat-conversion layers, release layers, intermediate dynamic release layers, propellant layers, and transfer-assist layers, and may provide one or more functionalities. One function of the transfer-assist layer is to convert the light radiation to heat energy in order to effect the thermal transfer of materials from the donor element to the receptor element.

In order for the transfer-assist layer to exhibit adequate performance in the thermal imaging process, i.e. to exceed a minimum threshold level of radiation absorption and light-to-heat conversion, the amount of functional component(s) incorporated in the transfer-assist layer must exceed a pre-determined minimum threshold level, the precise level being determined by the identity of the functional component, the identity of the transfer layer, and the thermal transfer method utilised. The materials in the transfer layer should be stable to the heat experienced during the imaging process, and the amount, identity and location of the radiation converter should be suitable to meter the correct amount of heat to the transfer layer in order to avoid degradation of the components thereof. For this reason, there is normally also a maximum threshold limit for the amount of radiation which should be absorbed by the transfer-assist layer. If too much radiation is absorbed and converted to heat by the radiation absorber in the transfer-assist layer, then too much heat energy can be transmitted to the materials of the transfer layer nearest the transfer-assist layer, which can lead to degradation and decomposition thereof.

Typically, a radiation absorber is also present in the transfer layer itself, which ensures the release of heat energy throughout the whole thickness of the transfer layer. Thus, a proportion of the radiation normally passes through the transfer-assist layer to the transfer layer itself to assist in the thermal transfer. The transfer-assist layer therefore functions not only to transmit heat-energy to the transfer layer, but also to shield the transfer layer from an excess of heat energy which would otherwise be experienced if all the radiation absorber were present in the transfer layer.

Ideally, irradiation induces adhesive failure at the interlayer boundary of the transfer layer and the transfer-assist layer, which would enable 100% transfer of the ink to the receptor sheet. Cohesive failure within the ink layer may result in incomplete transfer of ink, and cohesive failure within the transfer-assist layer may lead to components of the transfer-assist layer being deposited on the receptor sheet. In some instances, it is desirable that one or more components of the transfer-assist layer be transferred to the receptor substrate along with the transfer layer, which can improve the flow and adhesion of the transfer layer to the receptor surface and lead to a smooth image surface on the receptor. It is important that the image transferred to the receptor substrate should have a smooth surface to ensure that any subsequently applied layers (for instance indium tin oxide layers) are themselves smooth and defect-free. However, the transfer of certain other components of the transfer-assist layer to the receptor surface can be problematic and should be avoided. One such component is carbon black. Carbon black is typically used in conventional transfer-assist layers as a radiation-absorber to convert radiation to the heat required for the thermal transfer.

Donor elements having a polymeric substrate and a functional transfer-assist coating comprising a radiation-absorber are known in the art. These prior art donor elements typically utilise an organic material as the radiation-absorber, and require the use of organic solvents to apply the coating onto the substrate. These organic solvents can be environmentally toxic and costly to use and dispose of. It is an object of this invention to provide alternative elements and supports comprising a polymeric substrate and radiation-absorbing transfer-assist coating, particularly donor elements and supports which are more economic and less environmentally harmful to produce, and a method for their production.

As used herein, the term “donor element” comprises a donor support and a transfer layer.

As used herein, the term “radiation” refers to electromagnetic radiation, and particularly to the microwave, infrared, visible and ultraviolet regions thereof, and particularly the infrared, visible and ultraviolet regions thereof. The term “radiation” preferably refers to infrared radiation, i.e. the wavelength range from 0.75 μm to 1000 μm, and particularly to near-infrared radiation, i.e. the wavelength range from 780 to 1500 nm, particularly the wavelength range from about 800 to about 850 nm, particularly the wavelength range from about 825 to about 835 nm, and particularly a wavelength of incident infrared radiation of about 830 nm. The imaging radiation can be provided by any suitable radiation source, but is typically provided by one or more lasers. Infrared lasers are a particularly suitable source for providing image-wise light energy. In one embodiment the imaging light is provided by one or more diode lasers.

According to the present invention, there is provided a composite film suitable as a donor support in a radiation-induced thermal transfer imaging process, said film comprising a polymeric substrate and a transfer-assist coating layer derived from an aqueous composition comprising one or more water-soluble or water-dispersible radiation-absorbing compound(s).

Preferably, the aqueous composition further comprises one or more water-soluble or water-dispersible polymeric binder(s).

It is preferred that the composite film also comprises one or more humectant(s), which may be, and preferably is/are, disposed in the transfer-assist layer.

According to a further aspect of the present invention, there is provided an aqueous transfer-assist coating composition comprising one or more water-soluble or water-dispersible radiation-absorbing compound(s), optionally one or more water-soluble or water-dispersible polymeric binder(s), and optionally one or more humectant(s).

According to a further aspect of the present invention, there is provided a method of manufacture of a composite film suitable for use as a donor support in a radiation-induced thermal transfer imaging process, said composite film comprising a polymeric substrate and a transfer-assist coating, said transfer-assist coating comprising one or more water-soluble or water-dispersible radiation-absorbing compound(s) and optionally one or more water-soluble or water-dispersible polymeric binder(s), said process comprising the steps of:
(a) melt-extruding a substrate layer of polymeric material;
(b) stretching the substrate layer in a first direction;
(c) optionally stretching the substrate layer in a second, orthogonal direction;
(d) forming a transfer-assist coating layer by applying to a surface of the substrate an aqueous composition comprising said water-soluble or water-dispersible radiation-absorbing compound(s) and optionally said water-soluble or water-dispersible polymeric binder(s);
(e) optionally heat-setting the stretched film; and
(f) optionally winding the film to form a reel.

The process for coating the transfer-assist composition may be conducted either in-line or off-line. Preferably, the application of the transfer-assist layer to the polymeric substrate is conducted according to the present invention in an “in-line” process, i.e. wherein the coating step is effected during film manufacture. Thus, as used herein, an “in-line” coating process refers to a process wherein coating step (d) is either effected between steps (a) and (b); or between the two stretching steps (b) and (c) of a biaxial stretching process; or between steps (c) and (e) in the case of a biaxially stretched film or between steps (b) and (e) in the case of a monoaxially stretched film; or between steps (e) and (f). Typically, an “in-line” coating process is one in which the coating step (d) is conducted prior to step (c). As used herein, an “off-line” coating process is one in which the coating step is distinct from, and effected after, the process of film manufacture. Thus, an “off-line” coating step is conducted after step (f).

An in-line coating process has advantages of economy and efficiency over the prior art processes in which the coating step could typically only be conducted after the manufacture of the polymeric substrate has been completed, i.e. in an “off-line” manufacturing process, because organic solvents require inconvenient and costly drying procedures. In addition, an in-line coating process can surprisingly provide superior adhesion between the substrate layer and the coated layer, and superior imaging performance. While in-line coating methods are desirable from an economy and efficiency perspective, there are nevertheless inherent limitations to this coating technique. The use of organic solvents also means that costly apparatus is required in order to minimise the emission of undesirable pollutants into the atmosphere, which are not required with the aqueous compositions described herein.

The coat-weight, and therefore the coat-thickness, when solution coating should not exceed a level beyond which it becomes unfeasible to remove the aqueous solvent in an economic or efficient manner. In general, the range of dry coating thicknesses attainable by an in-line solution coating technique is from about 10 nm to about 2000 nm. Thicknesses lower than about 10 nm tend to lose their desired functionality and/or continuity; while thicknesses higher than about 2000 nm are impractical because of limitations of the coating facility, such as drying capacity. Heavier coatings can be applied using melt coating or 100% solids systems without having a drying limitation issue. The viscosity of the coating composition is typically be in the range of 1 to 100 Pas for gravure-type coating methods, but can be greater than 100 Pas for other coating methods. In addition, it is desirable that the functional components are compatible with each other to allow the formulation of a coating composition suitable for an in-line coating technique without particle flocculation, aggregation or crystallisation. Accordingly, there are inherent limitations on the amount of functional component(s) that can be incorporated into a transfer-assist layer applied using an in-line coating technique. However, the transfer-assist coating must contain an amount of radiation-absorber which exceeds a minimum threshold level, as noted hereinabove. There is therefore a trade-off between “in-line coatability” on the one hand and thermal transfer performance on the other.

Thus, it is preferred that the aqueous coating composition comprise a sufficient amount of radiation-absorber to exhibit adequate performance (i.e. exceeding a minimum threshold level of radiation absorption) as a transfer-assist layer in a thermal transfer process while simultaneously allowing the composition to be applied to a substrate via an in-line coating technique, particularly wherein the functional components of the coating composition are thermally stable during film manufacture and capable of forming an in-line coatable composition.

There is also provided the use of a composite film as defined herein comprising a polymeric substrate and a transfer-assist coating layer derived from an aqueous composition comprising one or more water-soluble or water-dispersible radiation-absorbing compound(s) and optionally one or more water-soluble or water-dispersible polymeric binder(s), as a donor support in a radiation-induced thermal transfer imaging process, particularly for the purpose of improving one or more characteristics of the donor support in said imaging process as defined herein.

There is also provided the use of an aqueous coating composition comprising one or more water-soluble or water-dispersible radiation-absorbing compound(s), and optionally one or more water-soluble or water-dispersible polymeric binder(s), and optionally one or more humectant(s), to provide a transfer-assist layer in a donor support suitable for use in a radiation-induced thermal transfer imaging process, particularly for the purpose of improving the characteristics of a donor support in a radiation-induced thermal transfer imaging process as defined herein.

As used herein, the term “aqueous composition” refers to a composition in which the aqueous solvent is a single phase at ambient temperatures (i.e. from about 15 to about 25° C.), and thereby suitable for coating, and wherein said aqueous solvent comprises at least 80%, preferably at least 85%, preferably at least 90%, preferably at least 95%, and in one embodiment at least 99%, by weight of water. In the embodiment where one or more co-solvents is/are present, the co-solvent is preferably selected from a low to medium molecular weight (i.e. no more than about 300) branched or unbranched aliphatic alcohol (including diols and polyols), for instance C₂-C₆ aliphatic alcohols such as isopropanol. A typical aqueous coating composition contains about 85% of the aqueous solvent by weight of the total weight of the coating composition.

The Substrate

The polymeric substrate of the composite film is a self-supporting film or sheet by which is meant a film or sheet capable of independent existence in the absence of a supporting base. The substrate may be formed from any suitable film-forming polymer, including polyolefin (such as polyethylene and polypropylene), polycarbonate, polyamide (including nylon), PVC and polyester. In a preferred embodiment, the substrate is polyester, and particularly a synthetic linear polyester.

The synthetic linear polyesters useful as the substrate may be obtained by condensing one or more dicarboxylic acids or their lower alkyl (up to 6 carbon atoms) diesters, eg terephthalic acid, isophthalic acid, phthalic acid, 2,5-, 2,6- or 2,7-naphthalenedicarboxylic acid, succinic acid, sebacic acid, adipic acid, azelaic acid, 4,4′-diphenyldicarboxylic acid, hexahydro-terephthalic acid or 1,2-bis-p-carboxyphenoxyethane (optionally with a monocarboxylic acid, such as pivalic acid) with one or more glycols, particularly an aliphatic or cycloaliphatic glycol, e.g. ethylene glycol, 1,3-propanediol, 1,4-butanediol, neopentyl glycol and 1,4-cyclohexanedimethanol. An aromatic dicarboxylic acid is preferred. An aliphatic glycol is preferred. Polyesters or copolyesters containing units derived from hydroxycarboxylic acid monomers, such as ω-hydroxyalkanoic acids (typically C₃-C₁₂) such as hydroxypropionic acid, hydroxybutyric acid, p-hydroxybenzoic acid, m-hydroxybenzoic acid, or 2-hydroxynaphthalene-6-carboxylic acid, may also be used.

In a preferred embodiment, the polyester is selected from polyethylene terephthalate and polyethylene naphthalate. Polyethylene terephthalate (PET) is particularly preferred.

The substrate may comprise one or more discrete layers of the above film-forming materials. The polymeric materials of the respective layers may be the same or different. For instance, the substrate may comprise one, two, three, four or five or more layers and typical multi-layer structures may be of the AB, ABA, ABC, ABAB, ABABA or ABCBA type. Preferably, the substrate comprises one, two or three layers, and preferably only one layer. In one embodiment, the substrate comprises three layers.

Formation of the substrate may be effected by conventional techniques well-known in the art. Conveniently, formation of the substrate is effected by extrusion, in accordance with the procedure described below. In general terms the process comprises the steps of extruding a layer of molten polymer, quenching the extrudate and orienting the quenched extrudate in at least one direction.

The substrate may be uniaxially-oriented, but is preferably biaxially-oriented, as noted above. Orientation may be effected by any process known in the art for producing an oriented film, for example a tubular or flat film process. Biaxial orientation is effected by drawing in two mutually perpendicular directions in the plane of the film to achieve a satisfactory combination of mechanical and physical properties.

In a tubular process, simultaneous biaxial orientation may be effected by extruding a thermoplastics polymer tube which is subsequently quenched, reheated and then expanded by internal gas pressure to induce transverse orientation, and withdrawn at a rate which will induce longitudinal orientation.

In the preferred flat film process, the substrate-forming polymer is extruded through a slot die and rapidly quenched upon a chilled casting drum to ensure that the polymer is quenched to the amorphous state. Orientation is then effected by stretching the quenched extrudate in at least one direction at a temperature above the glass transition temperature of the polyester. Sequential orientation may be effected by stretching a flat, quenched extrudate firstly in one direction, usually the longitudinal direction, i.e. the forward direction through the film stretching machine, and then in the transverse direction. Forward stretching of the extrudate is conveniently effected over a set of rotating rolls or between two pairs of nip rolls, transverse stretching then being effected in a stenter apparatus. Alternatively, the cast film may be stretched simultaneously in both the forward and transverse directions in a biaxial stenter. Stretching is effected to an extent determined by the nature of the polymer, for example polyethylene terephthalate is usually stretched so that the dimension of the oriented film is from 2 to 5, more preferably 2.5 to 4.5 times its original dimension in the or each direction of stretching. Typically, stretching is effected at temperatures in the range of 70 to 125° C. Greater draw ratios (for example, up to about 8 times) may be used if orientation in only one direction is required. It is not necessary to stretch equally in the machine and transverse directions although this is preferred if balanced properties are desired.

A stretched film may be, and preferably is, dimensionally stabilised by heat-setting under dimensional restraint at a temperature above the glass transition temperature of the polyester but below the melting temperature thereof, to induce crystallisation of the polyester. The actual heat-set temperature and time will vary depending on the composition of the film but should not be selected so as to substantially degrade the mechanical properties of the film. Within these constraints, a heat-set temperature of about 135° to 250° C. is generally desirable. The thermal stability of the components in the coating layer may require careful control of the heat-set temperature in order to avoid or reduce any degradation of those components. Preferably, the heat-set temperature is less than about 235° C., preferably less than 230° C.

Where the substrate comprises more than one layer, preparation of the substrate is conveniently effected by coextrusion, either by simultaneous coextrusion of the respective film-forming layers through independent orifices of a multi-orifice die, and thereafter uniting the still molten layers, or, preferably, by single-channel coextrusion in which molten streams of the respective polymers are first united within a channel leading to a die manifold, and thereafter extruded together from the die orifice under conditions of streamline flow without intermixing thereby to produce a multi-layer polymeric film, which may be oriented and heat-set as hereinbefore described. Formation of a multi-layer substrate may also be effected by conventional lamination techniques, for example by laminating together a preformed first layer and a preformed second layer, or by casting, for example, the first layer onto a preformed second layer.

The substrate layer is suitably of a thickness from about 5 to 350 μm, preferably from 12 to about 300 μm, particularly from about 20 to about 200 μm, and particularly from about 30 to about 200 μm. In one embodiment, the thickness is from about 20 to about 100 μm, preferably from about 30 to about 100 μm, preferably from about 30 to about 70 μm.

The substrate may contain any of the additives conventionally employed in the manufacture of polymeric films, such as voiding agents, lubricants, anti-oxidants, radical scavengers, UV absorbers, fire retardants, thermal stabilisers, anti-blocking agents, surface active agents, slip aids, optical brighteners, gloss improvers, viscosity modifiers and dispersion stabilisers. Fillers are particularly common additives for polymeric film and useful in modulating film characteristics, as is well-known in the art. Typical fillers include particulate inorganic fillers (such as metal or metalloid oxides, clays and alkaline metal salts, such as the carbonates and sulphates of calcium and barium) or incompatible resin fillers (such as polyamides and polyolefins, in a polyester film substrate) or a mixture of two or more such fillers, as are well-known in the art and described in WO-03/078512-A for example. The components of the composition of a layer may be mixed together in a conventional manner. For example, by mixing with the monomeric reactants from which the layer polymer is derived, or the components may be mixed with the polymer by tumble or dry blending or by compounding in an extruder, followed by cooling and, usually, comminution into granules or chips. Masterbatching technology may also be employed.

In one embodiment, the substrate comprises a small amount (typically 0.2% to 0.5% by weight of the polymer of the substrate layer) of a dye which can assist in the focussing of the radiation source (onto the radiation-absorber in the transfer-assist layer) during the thermal imaging step, thereby improving the efficiency of the heat transfer. This dye typically absorbs in the visible region (and in one embodiment around 670 nm). Suitable dyes are well-known in the art and include blue phthalocyanine pigment or green anthraquinone pigment, such as the widely commercially available Disperse Blue 60 and Solvent Green 28 dyes. U.S. Pat. No. 6,645,681, the disclosure of which is incorporated herein by reference, describes other ways in which the substrate may be modified to assist in the focussing of a laser radiation source in which the equipment comprises an imaging laser and a non-imaging laser wherein the non-imaging laser has a light detector that is in communication with the imaging laser. In particular, the substrate may be modified by the incorporation therein of a light attenuating agent or by physically roughening a surface thereof. The light attenuating agent may be an absorber or a diffuser, or a mixture thereof. The wavelength ranges at which the imaging and non-imaging laser operate (typically in the range from about 300 nm to about 1500 nm) determine the wavelength ranges in which the absorber(s) and/or diffuser(s) are active and inactive. For example, if the non-imaging laser operates in about the 670 nm region and the imaging laser at 830 nm, it is preferred that the absorber and/or diffuser operate to absorb or diffuse light in the 670 nm region, rather than in the 830 nm region. Typical absorbers include blue phthalocyanine pigments with significant absorption in about the 670 nm range and minimal absoption at 830 nm; such as C.I. Pigment Blue 15 or 15-3 (Sun Chemical Corporation, Cincinnati, Ohio). Light diffusers include those materials which scatter light or scatter and absorb light and include white pigments such as titanium dioxide. The light attenuating agent is used in an amount effective to absorb or diffuse the light from the non-imaging laser, and typically in an amount sufficient to achieve an optical density (OD) ranging from about 0.1 to about 2.0, typically from about 0.3 to about 1.5, even more typically about 1.2. (Optical density is the absolute value of log (base 10) I₀/I where I₀ is the intensity of the incident light and I is the intensity of the light transmitted. An optical density of about 0.1 to 3 or higher corresponds approximately to an absorption of 20 to 99.9% or more of incident radiation.) At an optical density above about 2.0 the base is likely to be too highly absorbing for the imaging process and below about 0.1 there might not be a sufficient attenuating effect.

The substrate is preferably unfilled or only slightly filled, i.e. any filler is present in only small amounts, generally not exceeding 0.5% and preferably less than 0.2% by weight of the substrate polymer. In this embodiment, the substrate will typically be optically clear, preferably having a % of scattered visible light (haze) of <6%, more preferably <3.5% and particularly <2%, measured according to the standard ASTM D 1003. Preferably, the substrate exhibits a transmittance of the imaging radiation of at least 85%, preferably 90% or more, and in one embodiment at least 95%. In a further embodiment, the substrate exhibits a transmittance of the imaging radiation of between about 85% and 95% and in one embodiment, about 90%.

The surface characteristics of the substrate will depend on the application for which the imaged article is to be used. Typically, it will be desirable for the substrate, or at the least the surface of the substrate nearest to the thermally transferred layer, to be smooth (for instance as exhibited by a substantially unfilled film) so as not to impart adverse texture to the surface of the thermally transferred layer. This is especially important for applications requiring rigid dimensional tolerances such as for colour filter elements for liquid crystal displays. However, for other applications surface roughness or relief may be tolerable or even desirable.

In one embodiment, one side (or both sides, typically one side) of the substrate may be coated with a “slip coating” comprising a particulate material in order to assist in the handling of the film, for instance to improve windability and minimise or prevent “blocking”. The slip coating could be applied to either side of the substrate, but is preferably applied to the reverse surface of the substrate, i.e. the surface opposite to the surface on which is coated the transfer-assist coating. Suitable slip coatings may comprise potassium silicate, such as that disclosed in, for example, U.S. Pat. Nos. 5,925,428 and 5,882,798, the disclosures of which is incorporated herein by reference. Alternatively, a slip coating may comprise a discontinuous layer of an acrylic and/or methacrylic polymeric resin optionally further comprising a cross-linking agent, as disclosed in, for example, EP-A-0408197, the disclosure of which is incorporated herein by reference.

In a further embodiment, the reverse side of the polymeric substrate is coated with an antistatic agent using conventional techniques, such as those described herein, in order to improve contamination control and improve transport of the film. The slip additive referred to hereinabove may be added to an antistatic coating. Static charge build-up can be controlled by increasing the electrical conductivity of a material, and antistatic agents typically operate by dissipating static charge as it builds up. Thus, static decay rate and surface conductivity are common measures of the effectiveness of antistatic agents. Any conventional antistatic agent can be used in the present invention. Known antistatic agents cover a broad range of chemical classes, including organic amines and amides, esters of fatty acids, organic acids, polyoxyethylene derivatives, polyhydridic alcohols, metals, carbon black, semiconductors, and various organic and inorganic salts. Anti-static coatings may also contain anti-blocking inorganic or organic components such as silica, acrylic and/or methacrylic resins such as poly(methyl methacrylate) (PMMA), polystyrene and the like, typically in particulate form, to improve handleability and film transport. In one embodiment, the coating on the reverse side of the polymeric substrate comprises PMMA (particularly wherein the PMMA is in the form of particles having a diameter in the range of from about 0.1 to about 0.3 μm, and particularly about 0.2 μm). Various antistatic media are disclosed in U.S. Pat. No. 5,589,324, U.S. Pat. No. 4,225,665, EP-A-0036702, EP-A-0027699, EP-A-0190499, EP-A-0678546 and WO-A-02/081227 and the documents referenced therein, the disclosures of which are incorporated herein by reference. Many antistatic agents are also surfactants and can be neutral or ionic in nature. Preferably, such an antistatic coating is characterised in that it exhibits a surface resistivity of greater than 16 log₁₀ ohms/square at a relative humidity of 2% and a surface resistivity of 16 log₁₀ ohms/square or less at a relative humidity of 50%, particularly at a temperature of 25° C. It is recognised that temperature variation typically has only a second order effect on surface resisitivity within normal operating temperatures (for instance within 0 to 100° C. ). The dried coating typically exhibits a dry coat weight of from about 0.1 to about 10 mg/dm⁻². The thickness of an antistatic layer is generally within a range of from 0.01 to 1.0 μm.

In a further embodiment, the substrate may be coated with a primer layer to improve the adhesion of the transfer-assist layer thereto. In one embodiment, a primer layer can be applied before any stretching operations are conducted on the cast film, and the transfer-assist coating layer can be applied subsequently, e.g. either after a first stretching operation and before a second stretching operation or after both stretching operations.

In a further embodiment, the light-attenuating agent referred to hereinabove may be present in a discrete layer, referred to as light-attenuating layer, which may be coated on the substrate by conventional techniques for instance as an aqueous dispersion of the light attenuating agent in a binder (such as a copolymer of methylmethacrylate and n-butylmethacrylate, or those referred to herein for the transfer layer) optionally with a minor amount of surfactant (such as a fluoropolymer).

The Transfer-Assist Coating

The transfer-assist layer should exhibit a radiation transmission in the range of from about 20% to about 80%, preferably from about 20% to about 60%, preferably from about 30% to about 50%, more preferably from about 40% to about 50%, at the wavelength of the imaging radiation used in the thermal transfer imaging process.

The degree of radiation transmission of the transfer assist layer is affected by the identity and amount of the radiation-absorbing compound in the transfer-assist layer, and the thickness of the transfer-assist layer.

The radiation-absorbing compound is preferably present in an amount from about 2% to about 85% by weight of the solids fraction in the coating composition, preferably about 5% to about 60% by weight, preferably about 5% to about 50% by weight, preferably about 10% to about 30% by weight. In one embodiment, the radiation-absorbing compound is present in an amount from about 15% to about 85% by weight of the solids fraction in the coating composition, preferably about 15% to about 60% by weight, preferably about 15% to about 50% by weight, and preferably about 20% to about 40% by weight.

The dry thickness of the transfer-assist coating layer is preferably no more than about 5 μm, preferably no more than about 2 μm, and preferably no more than about 1 μm, and is preferably at least 0.05 μm. In preferred embodiments, the dry thickness of the transfer-assist coating layer is from about 0.05 to about 1 μm, preferably from about 0.1 μm to about 0.6 μm, preferably from about 0.15 μm to about 0.6 μm, and more preferably 0.5 μm or less. It is surprising that such layer thicknesses, particularly in combination with the preferred levels of radiation-absorbing compound described hereinabove, would be capable of functioning as a transfer-assist layer.

Of course, the radiation-absorbing compound need only absorb radiation at the desired wavelength(s) of the imaging radiation and may be transparent to radiation of other wavelengths. For instance, a radiation-absorber which absorbs in the near-infrared region or portion thereof may not absorb in the visible region. Where the thermal imaging process utilises an imaging laser and a non-imaging laser, as described in U.S. Pat. No. 6,645,681 referred to hereinabove, the radiation-absorbing compound of the radiation of the imaging laser (referred to hereinafter as the “imaging radiation-absorbing compound”) is preferably relatively transparent to the radiation of the non-imaging laser. Thus, the optical density of the imaging radiation-absorbing compound in the wavelength region of the imaging laser is preferably greater than the absorbance optical density of the imaging radiation-absorbing compound in the wavelength region of the non-imaging laser, and is preferably greater by a factor of at least 2, preferably at least 5, preferably at least 10, preferably at least 50, and preferably more.

The radiation-absorbing compound(s) should be sufficiently thermally stable to retain functionality at the processing conditions experienced during film manufacture. In particular, it is preferred that the decomposition temperature of the radiation-absorbing compound is at least 180° C., preferably at least 200° C., preferably at least 220° C. and preferably at least 235° C.

The radiation-absorbing compound is preferably also selected on the basis of its solubility or dispersibility in water; its compatibility with a specific binder of the transfer-assist layer; and the wavelength ranges of absorption required for the transfer-assist layer. Soluble and dispersible radiation-absorbing compounds promote homogenous thin layers which absorb radiation homogenously, and without scattering of the incident radiation, which can occur with particulate materials.

Suitable radiation-absorbing materials are selected from dyes (such as visible dyes, ultraviolet dyes, infrared dyes, fluorescent dyes and radiation-polarizing dyes), pigments, metals and metal-containing compounds, metallized films (for instance those formed by sputtering and evaporative deposition techniques to a pre-determined degree of metallization allowing radiation transmission within desired thresholds), and a wide range of suitable materials are well known in the art. Examples of dyes and pigments suitable as radiation-absorbers include cyanine compounds (including indocyanines, phthalocyanines, polysubstituted phthalocyanines; metal-containing phthalocyanines; and merocyanines); squarylium compounds; pyrylium compounds (including thiopyrylium compounds); thiopyrylium-squarylium compounds; chalcogenopyryloacrylidene compounds; bis(chalcogenopyrylo) polymethine compounds; croconium and croconate compounds; benzoxazole compounds; benz[e, f or g]indolium compounds; metal thiolate compounds; oxyindolizine compounds; indolizine compounds; metal-complex compounds including metal dithiolene compounds (such as nickel dithiolenes); bis(aminoaryl) polymethine compounds; thiazine compounds; azulenium compounds; xanthene compounds; and quinoid compounds. Particularly useful radiation absorbing dyes are of the cyanine class. Radiation-absorbing materials are disclosed in U.S. Pat. No. 5,972,838; U.S. Pat. No. 5,108,873; U.S. Pat. No. 5,036,040; U.S. Pat. No. 5,035,977; U.S. Pat. No. 5,034,303; U.S. Pat. No. 5,024,923; U.S. Pat. No. 5,019,549; U.S. Pat. No. 5,019,480; U.S. Pat. No. 4,973,572; U.S. Pat. No. 4,952,552; U.S. Pat. No. 4,950,640; U.S. Pat. No. 4,950,639; U.S. Pat. No. 4,948,778; U.S. Pat. No. 4,948,777; U.S. Pat. No. 4,948,776; U.S. Pat. No. 4,942,141; U.S. Pat. No. 4,923,638; U.S. Pat. No. 4,921,317; U.S. Pat. No. 4,913,846; U.S. Pat. No. 4,912,083; U.S. Pat. No. 4,892,584; U.S. Pat. No. 4,791,023; U.S. Pat. No. 4,788,128; U.S. Pat. No. 4,767,571; U.S. Pat. No. 4,675,357; U.S. Pat. No. 4,508,811; U.S. Pat. No. 4,446,223; U.S. Pat. No. 4,315,983; and U.S. Pat. No. 3,495,987.

A source of suitable infrared-absorbing dyes is H. W. Sands Corporation (Jupiter, Fla., US). Suitable dyes include 2-[2-[2-(2-pyrimidinothio)-3-[2-(1,3-dihydro- 1,1-dimethyl-3-(4-sulphobutyl)-2H-benz[e]indol-2-ylidene)]ethylidene-1-cyclopenten-1-yl]ethenyl]-1,1dimethyl-3-(4-sulphobutyl)-1H-benz[e]indolium, inner salt, sodium salt; and indocyanine green, having CAS No. [3599-32-4]. A preferred dye is 2-(2-(2-chloro-3-(2-(1,3-dihydro-1,1-dimethyl-3-(4-sulphobutyl)-2H-benz[e]indol-2-ylidene)ethylidene)-1-cyclohexene-1-yl)ethenyl)-1,1-dimethyl-3-(4-sulphobutyl)-1H-benz[e]indolium, inner salt, free acid having CAS No. [162411-28-1].

Examples of other such dyes may be found in “Infrared Absorbing Materials” (Matsuoka, M., Plenum Press, New York, 1990), and in “Absorption Spectra of Dyes for Diode Lasers” (Matsuoka, M., Bunshin Publishing Co., Tokyo, 1990). Infrared-absorbers can also be selected from those marketed by American Cyanamid Co. (Wayne, N.J.), Cytec Industries (West Paterson, N.J.) or by Glendale Protective Technologies, Inc., Lakeland, Fla., including those with the designation CYASORB IR-99, IR-126 and IR-165 (N,N′-2,5-cyclohexadiene-1,4-diylidenebis[4-(dibutylamino)-N-[4-(dibutylamino)phenyl]benzenaminium bis[(OC-6-11)-hexafluoroantimonate(1—)]. Other suppliers include Hampford Research Inc (Stratford, Conn.).

Pigmentary materials for use in the transfer-assist layer as radiation absorbers can be selected from carbon black and graphite; black azo pigments based on copper or chromium complexes of, for example, pyrazolone yellow, dianisidine red; oxides and sulphides of metals such as aluminum, bismuth, tin, indium, zinc, titanium, chromium, molybdenum, tungsten, cobalt, iridium, nickel, palladium, platinum, copper, silver, gold, zirconium, iron, lead or tellurium; and metal borides, carbides, nitrides, carbonitrides, bronze-structured oxides, and oxides structurally related to the bronze family are also of utility.

The water-soluble or water-dispersible polymeric binder suitable for use in the present invention may be selected from a variety of materials, including polyurethanes; polyols (including PVOH and EVOH); polyolefins (such as polyethylene and polystyrenes (such as polyalpha-methylstyrene)) and polyolefin waxes; polyolefin/bisamide; polyvinylpyrrolidones (PVP); pyrrolidone/vinylacetate copolymers (PVP/VA); polyacrylic resins; polyalkylmethacrylates (particularly polymethylmethacrylates (PMMA)); acrylic and methacrylic copolymers; sulphonated acrylic and methacrylic copolymers; ethylene/acrylic acid copolymers; acrylic/silica resins (such as Sanmol™); polyesters (including sulphonated polyesters); cellulosic esters and ethers (such as hydroxyethyl and carboxymethyl cellulose); nitrocelluloses; polyimines (such as polyethyleneimine); polyamines (such as polyallylamine); styrene/maleic anhydride copolymers; sulphonated styrene/maleic anhydride copolymers; copolymers of sulphonated styrene, hydrolysed maleic anhydride and its esters; maleic acid-based polymers (such as poly(maleic acid)); quaternary ammonium group-containing polymeric compounds; Fisher Tropsh nonionic emulsion (available as Michem 64540); polysaccharide resins; halogenated polyolefins including PTFE and polychlorotrifluoroethylene (PCTFE); copolyester resins in alcohol (such as those commercially available as Vylonal™); ethylene vinyl acetate resins; polyoxazoline; high MW polyolefin alcohols (poly ethylene oxide); polyoxymethylene; gelatin; phenolic resins (such as novolak and resole resins); polyvinylbutyral resins; polyvinyl acetates; polyvinyl acetals; polyvinylidene chlorides and fluorides; polyvinyl chlorides and fluorides; polycarbonates; and polyalkylenecarbonates. The binder may also comprise the condensation product of an amine such as melamine with an aldehyde such as formaldehyde, optionally alkoxylated (for instance methoxylated or ethoxylated). In addition, the binders recited herein for the transfer layer may also be used in the transfer-assist layer. In one embodiment, the binder comprises a relatively minor proportion of a hydrophobic substance such as a wax in the form of an aqueous dispersion, and suitable examples included polyolefin waxes (such as polypropylene waxes) available for instance as Michem 43040.E (polypropylene emulsion); Michem 48040 (microcrystalline wax emulsion) and Michem 67135 (carnauba wax emulsion) all available from Michelman International & Co. Belgium.

Preferably, the average particle size of a water-dispersible binder in its aqueous phase is less than 0.1 μm and more preferably less than 0.05 μm, and preferably having a narrow particle size distribution, in order to promote a homogeneous coating layer.

Preferred binders are those which show good compatibility with the radiation absorber, and allow higher loadings of the radiation absorber (which may be necessary to achieve the optimum radiation absorbance) into the transfer-assist coating layer without significant loss of adhesion of the transfer-assist coating to the substrate layer. Higher loadings of radiation absorber increase the amount of radiation absorbed by the transfer-assist coating.

In one embodiment, the binder is selected from the group consisting of acrylic and/or methacrylic resins and optionally sulphonated polyesters, and preferably from polyesters.

Preferred polyesters are selected from copolyesters comprising functional comonomers which improve hydrophilicity, and which typically introduce pendant ionic groups, preferably an anionic group, into the polyester backbone, for instance pendant sulphonate or carboxylate groups, as is well known in the art.

Suitable hydrophilic polyesters include partially sulphonated polyesters, including copolyesters having an acid component and a diol component wherein the acid component comprises a dicarboxylic acid and a sulphomonomer containing a sulphonate group attached to the aromatic nucleus of an aromatic dicarboxylic acid. In a preferred embodiment, the sulphomonomer is present in the range of from about 0.1 to about 10 mol %, preferably in the range of from about 1 to about 10 mol %, and more preferably in the range from about 2 to about 6%, based on the weight of the copolyester. In one embodiment, the number average molecular weight of the copolymer is in the range of from about 10,000 to about 15,000. Preferably, the sulphonate group of the sulphomonomer is a sulphonic acid salt, preferably a sulphonic acid salt of a Group I or Group II metal, preferably lithium, sodium or potassium, more preferably sodium. Ammonium salts may also be used. The aromatic dicarboxylic acid of the sulphomonomer may be selected from any suitable aromatic dicarboxylic acid, e.g. terephthalic acid, isophthalic acid, phthalic acid, 2,5-, 2,6- or 2,7-naphthalenedicarboxylic acid. Preferably the aromatic dicarboxylic acid of the sulphomonomer is isophthalic acid. Preferred sulphomonomers are 5-sodium sulpho isophthalic acid and 4-sodium sulpho isophthalic acid. The non-sulphonated acid component is preferably an aromatic dicarboxylic acid, preferably terephthalic acid.

One class of suitable acrylic resin comprises at least one monomer derived from an ester of acrylic acid, preferably an alkyl ester wherein the alkyl group is a C₁₋₁₀ alkyl group, such as methyl, ethyl, n-propyl, isopropyl, n-butyl, isobutyl, t-butyl, hexyl, 2-ethylhexyl, heptyl and n-octyl, and more preferably ethyl and butyl. In one embodiment, the resin comprises alkyl acrylate monomer units and further comprises alkyl methacrylate monomer units, particularly wherein the polymer comprises ethyl acrylate and alkyl methacrylate (particularly methyl methacrylate). In a preferred embodiment, the alkyl acrylate monomer units are present in a proportion in the range of from about 30 to about 65 mole % and the alkyl methacrylate monomer units are present in a proportion in the range of from about 20 to about 60 mole %. A further class of acrylic resin comprises at least one monomer derived from an ester of methacrylic acid, preferably an alkyl ester, as described above, and preferably methyl ester. Other monomer units which may be present include acrylonitrile, methacrylonitrile, halo-substituted acrylonitrile, halo-substituted methacrylonitrile, acrylamide, methacrylamide, N-methylol acrylamide, N-ethanol acrylamide, N-propanol acrylamide, N-methacrylamide, N-ethanol methacrylamide, N-methylacrylamide, N-tertiary butyl acrylamide, hydroxyethyl methacrylate, glycidyl acrylate, glycidyl methacrylate, dimethylamino ethyl methacrylate, itaconic acid, itaconic anhydride and half ester of itaconic acid; vinyl esters such as vinyl acetate, vinyl chloracetate and vinyl benzoate, vinyl pyridine, vinyl chloride, vinylidene chloride, maleic acid, maleic anhydride, styrene and derivatives of styrene such as chlorostyrene, hydroxystyrene and alkylated styrenes wherein the alkyl group is a C₁₋₁₀ alkyl group. In one embodiment, the acrylic resin comprises about 35 to 60 mole % ethyl acrylate, about 30 to 55 mole % methyl methacrylate and about 2 to 20 mole % methacrylamide. In a further embodiment, the resin is a polymethylmethacrylate, optionally wherein one or more further comonomer(s) (such as those described above) is/are copolymerised in minor amounts (typically no more than 30%, typically no more than 20%, typically no more than 10% and in one embodiment, no more than 5%). Typically, the molecular weight of the resin is from about 40,000 to about 300,000, and more preferably from about 50,000 to about 200,000.

An acrylic resin suitable for use as the binder component can be in the form of an acrylate hydrosol. Acrylate-based hydrosols have been known for some time (Beardsley and Selby, J. Paint Technology, Vol.40 521, pp263-270, 1968), and the production thereof is described in GB-1114133-B and GB-1109656-B. Other acrylate hydrosols are disclosed in U.S. Pat. No. 5,047,454 and U.S. Pat. No. 5,221,584, the disclosures of which are incorporated herein by reference. In one embodiment, an acrylate hydrosol is selected from those disclosed in U.S. Pat. No. 4,623,695 the disclosure of which is incorporated herein by reference. Thus, the acrylic hydrosol may be prepared by the polymerization of:
(a) from about 30 to about 99% by weight of at least one (meth)acrylic acid ester of a C₁₋₈ alcohol,
(b) from about 0.5 to about 7% by weight of at least one ethylenically unsaturated acid or amide thereof, and
(c) from 0 to about 70% by weight of at least one monomer selected from the group consisting of styrene, methyl styrene, acrylonitrile, vinyl acetate, and vinyl chloride, in aqueous emulsion, and particularly wherein the polymerization is carried out in the presence of an emulsifier mixture of (i) at least one alkyl phenol ether sulphate and (ii) at least one of an α-sulphocarboxylic acid, a C₁₋₄ ester thereof, or a salt of either of the foregoing, wherein the carboxylic acid portion thereof contains from 8 to 24 carbon atoms. Typically, the molecular weight of the polymer is in the range of from about 10,000 to about 1,000,000, particularly 40,000 to about 500,000.

In one embodiment, the binder is selected from PTFE; polyvinyl fluoride (PVF); polyvinylidene fluoride (PVDF); polychlorotrifluoroethylene (PCTFE); polyvinylidene chloride (PVDC); polyvinylchloride (PVC); nitrocelluloses; polymethylmethacrylates; polyalpha-methylstyrene; polyalkylenecarbonates; and polyoxymethylene, and particularly from nitrocelluloses; polymethylmethacrylates; and polyalkylenecarbonates (particularly wherein the alkylene group is a C₁-C₈ alkylene group, particularly a C₁-C₄ alkylene, and particularly ethylene or polypropylene). In a further embodiment, the binder is selected from polyalkylenecarbonates. In a further embodiment, the binder is selected from nitrocelluloses. In a further embodiment, the binder is selected from polymethylmethacrylates.

In a further embodiment, the binder is selected from maleic anhydride polymers or copolymers such as styrene maleic anhydride copolymers.

In a further embodiment, the binder is selected from polyvinylbutyral resins.

In a further embodiment, the binder is selected from PVOH; polyvinylpyrrolidones (PVP); polysaccharide resins; high MW polyolefin alcohols (particularly poly(ethylene oxide)); gelatin; and cellulosic esters and ethers (particularly hydroxyethyl cellulose. In this embodiment, the binder is optionally in the form of a hydrophilic polymer blend with polyester sulphonates (e.g. Amertech Polyester Clear; American Inks and Coatings Corp; Valley Forge; Pa.), as described herein.

The weight ratio of radiation absorber to binder is generally from about 5:1 to about 1:100 by weight, depending on the binder and radiation absorber used. In one embodiment, the weight ratio of radiation absorber to binder is 4:100 to about 90:100 by weight, more preferably about 8:100 to about 1:2 by weight, more preferably about 1:10 to about 1:5 by weight. In an alternative embodiment, the weight ratio of radiation absorber to binder is 2:1 to about 1:20 by weight, more preferably about 1:1 to about 1:7 by weight,

The transfer-assist layer preferably also comprises one or more humectant(s) which are hygroscopic and increase the amount of water present in the donor element under ambient environmental conditions, and/or retain any water present therein under ambient conditions, prior to the use of the donor element in a thermal transfer process. The presence of a humectant has been found unexpectedly to improve the transfer of material to the receiver element during imaging. It is believed that water present in the donor element and specifically in the transfer-assist layer is released from the composite film under the influence of the heat generated by the radiation in the thermal imaging process. The humectant component preferably makes up at least 0.05% of the solids fraction in the transfer-assist coating composition, and typically no more than about 70%, preferably no more than about 50%, preferably no more than about 40%. In preferred embodiments, the humectant makes up from about 0.05% to about 30%, preferably from about 0.05 to about 20%, preferably from about 0.05 to about 10% of the solids fraction in the transfer-assist coating composition. In one embodiment, the humectant is present in the range of about 0.05% to about 5% by weight of the solids component, more typically in the range of from about 0.05% to about 2% by weight, and in one embodiment in an amount of about 1.0% by weight of the solids fraction. In a further embodiment, the humectant is present in an amount of about 0.2% by weight of the solids fraction.

The humectant component should be compatible with the radiation absorber in that it allows the production of a homogeneous or substantially homogeneous coating. A compatible system is one in which there is essentially no agglomeration of particles, and no phase rich in a particular component, so as to allow a uniform transfer of the coating layer to the substrate. In one embodiment, the humectant is a material which absorbs at least 10%, preferably at least 25%, preferably at least 40%, preferably at least 55%, preferably at least 70%, preferably at least 85%, preferably at least 100% of its weight in water at 90% relative humidity at 27° C. within 24 hours, preferably reaching equilibrium within this period. In one embodiment, the humectant absorbs at least 125%, preferably at least 150% of its weight in water at 90% relative humidity at 27° C. within 24 hours, preferably reaching equilibrium within this period.

Humectants may be selected from a variety of materials, and typical chemical functionalities in humectants include hydroxyl groups (e.g. polyvinylalcohol (PVOH) and ethylene-vinyl alcohol copolymers (EVOH)); carboxylic acid groups (e.g. organic benzoate, fatty acids); ester groups (e.g. fatty acid esters, including glycerol esters); acetate groups; amine groups (particularly tertiary amines and polyamines (such as kemamines) and their salts especially quaternary ammonium salts (e.g. Larostats)); amide groups (e.g. fatty acid amides and their quaternary salts); quaternary salts (particularly quaternary ammonium salts, such as quaternary ammonium methosulphates); organic sulphate and sulphonate salts (e.g. alkyl sulphonates (such as sodium lauryl sulphonate), p-toluenesulphonic acid (PTSA), sulphosalicylic acid, sulphosuccinates, sulphonated polyesters, polystyrenesulphonates, sulphonated vinyl/acryclics etc); phosphoric acid and phosphate salts (e.g. ethyl acid phosphate, potassium ethyl phosphate); phosphonic acid and dihydrogenphosphate salts (e.g. quaternary ammonium dihydrogenphosphate); phosphate esters; nitric acid and nitrate salts; and polar groups (e.g. halides and cyanide). Polymeric humectants include poly(ethylene oxide) compounds and derivatives and polymer electrolytes such as poly(ethylene oxide) salts (particularly the lithium salts); polyvinylpyrrolidones and their salts; polycarboxylic acids and their salts (e.g. GlasCOl™ RP2); polyamine salts (e.g. Alcostat™ RP1); and polystyrenesulphonates. Other polymeric humectants include gelatin; cellulosics (e.g. hydroxyethylcellulose); polysaccharides (e.g. starch); and chitosan and its salts. Surfactant humectants may be non-ionic (e.g. glycerol monostearates, glycerides, ethoxylated/propoxylated and glycerol derivatives of alkylamines such as tallow amines (e.g. Armostat™ 600, an alkyl bis(2-hydroxyethyl)amine)); cationic (e.g. fluorosurfactants); anionic (e.g. fluorosurfactants); or zwitterionic (e.g. (sulpho)betaines). Many inorganic compounds also have humectant properties, including salts such as sodium chloride, and other salts having water of crystallisation properties. Other examples of inorganic compounds with humectant properties include sodium silicate, laponite, zirconates and titanates (particularly the neoalkoxy compounds), and those having boron-containing cations. Examples of humectants include potassium (dimethylaminoethanol) ethylphosphate; stearamidopropyldimethyl-β-hydroxyethylammonium-dihydrogen phosphate; amine-containing ethoxylated materials such as Elfugin PF; N,N,N′-tris(2-hydroxyethyl)-N,N′-dimethyl-N′-octadecyl-1,3-propanediaminium bis(methyl sulphate) salt; trifluoromethanesulphonate salts, lauryl sulphonate salts, and 2-ethylhexyl sulphosuccinate salts (including the ammonium, sodium, potassium and lithium salts). In one embodiment, the humectant is selected from potassium (dimethylaminoethanol) ethylphosphate; sodium chloride; sorbitan monostearate; fatty acid esters, such as glycerol esters, including glycerol mono-oleate; and quaternary ammonium dihydrogenphosphate.

In one embodiment, the polymeric binder may itself provide humectant properties, and the incorporation of a separate humectant is not necessary. Suitable binder-humectants may be selected according to the above physical characteristics, and should be capable of absorbing water as well as forming a film. Suitable binder-humectant materials include PVOH and cellulosic esters and ethers. In one embodiment, the NIR dye may itself provide humectant properties.

The transfer-assist layer preferably also comprises one or more surfactant(s), preferably anionic and/or nonionic surfactants, to improve wetting of the transfer-assist coating on the surface of the polymeric substrate. Suitable surfactants include polyether-modified trisiloxanes, ethoxylated alkyl phenols, polyoxyethylene-fatty acid ester, sorbitan fatty acid ester, glycerine fatty acid ester, alkyl sulphate, alkyl sulphonate and alkyl sulphosuccinate. Silicone surfactants and fluoro-surfactants conventional in the art may also be used. In one embodiment, the surfactant is a polyether-modified trisiloxane surfactant. The surfactant is present in only minor amounts in the coating composition, preferably in the range of 0 to 10%, preferably 0 to 8%, more preferably 0 to 4% by weight of the composition, and typically about 1% by weight.

The transfer-assist layer preferably also comprises a cross-linking agent which functions to improve the adhesion of the coating to the polymeric substrate, and also to exhibit some resistance to the solvent of the inks applied as the transfer layer. Suitable cross-linking agents include epoxy resins, alkyd resins, oxazolidines, polyfunctional aziridines, resorcinol formaldehyde resins, phenolformaldehyde resins, amine derivatives (such as hexamethoxymethyl melamine) and condensation products of an amine such as melamine, diazine, urea, cyclic ethylene urea, cyclic propylene urea, thiourea, cyclic ethylene thiourea, alkyl melamines, aryl melamines, benzo guanamines, guanamines, alkyl guanamines and aryl guanamines) with an aldehyde (such as formaldehyde). In one embodiment, the cross-linking agent is a condensation product of melamine with formaldehyde. The condensation product may optionally be alkoxylated, for example methoxylated or ethoxylated. The cross-linking agent may be used in amounts of up to about 50% by weight based on the weight of the solid of the transfer-assist layer, more typically up to about 25%, and typically in the range of 5 to 20% by weight of solids. A catalyst is preferably employed to facilitate the cross-linking action of the cross-linking agent. Preferred catalysts wherein the cross-linker comprises melamine formaldehyde include ammonium chloride, ammonium nitrate, ammonium thiocyanate, ammonium dihydrogen phosphate, ammonium sulphate, ammonium paratoluene sulphonate, diammonium hydrogen phosphate, para-toluene sulphonic acid, maleic acid stabilised by reaction with a base, and morpholinium paratoluene sulphonate.

Other optional additives to the coating composition include pH modifiers, viscosity modifiers and co-solvents, and such additives are typically present only in minor amounts in the coating composition, preferably in the range of 0 to 20%, preferably 0 to 10%, preferably 0 to 8%, and more preferably 0 to 5% by weight of the composition. Suitable pH modifiers are well-known in the art, and include for instance ammonium hydroxide and dimethylaminoethanol (DMAE). The pH modifier serves to improve the compatibility of the aqueous dispersions or solution of radiation absorber and binder, if necessary. In one embodiment, it is preferred that a pH modifier should not have an influence on viscosity, and also that the pH modifier should not evaporate before, immediately upon, or soon after, application of the coating composition on the substrate, and DMAE is preferred in these respects. Suitable viscosity modifiers are also known in the art, and include for instance isopropanol. In one embodiment, it is preferred that the use of pH modifier(s) and/or viscosity modifier(s) should not have an influence on the absorption peak or transmittance of the transfer-assist coating.

The light-attenuating agent of U.S. Pat. No. 6,645,681 referred to herein above may be incorporated into the transfer-assist layer instead of, or additionally to, the substrate.

In the preparation of the coating composition, it is preferred to add the various components to the aqueous solvent. The precise mixing sequence is one which allows the various components, particularly the radiation-absorber, to completely dissolve or disperse in the aqueous vehicle, and one which promotes the most compatible and stable final composition, without flocculation, agglomeration or an unsuitable increase in viscosity.

The coating process for the application of the transfer layer is described in general terms hereinabove. In one embodiment, the coating composition should be applied to the film substrate between the two stages (longitudinal and transverse) of a biaxial stretching operation. Such a sequence of stretching and coating is especially preferred for the production of a coated film substrate which is preferably firstly stretched in the longitudinal direction over a series of rotating rollers, coated with the coating composition, and then stretched transversely in a stenter oven, preferably followed by heat setting. The coating composition may be applied to the substrate by any suitable conventional coating technique such a gravure roll coating, reverse roll coating, dip coating, bead coating, slot coating or electrostatic spray coating. Where the coating composition is applied before a stretching operation, the coating layer should be capable of stretching with the base film.

Prior to deposition of the coating composition onto the polymeric substrate, the exposed surface thereof may, if desired, be subjected to a chemical or physical surface-modifying treatment to improve the bond between that surface and the subsequently applied coating composition. A preferred treatment, because of its simplicity and effectiveness, is to subject the exposed surface of the substrate to a high voltage electrical stress accompanied by corona discharge. Alternatively, the substrate may be pretreated with an agent known in the art to have a solvent or swelling action on the substrate polymer. Examples of such agents, which are particularly suitable for the treatment of a polyester substrate, include a halogenated phenol dissolved in a common organic solvent e.g. a solution of p-chloro-m-cresol, 2,4-dichlorophenol, 2,4,5- or 2,4,6-trichlorophenol or 4-chlororesorcinol in acetone or methanol. The preferred treatment by corona discharge may be effected in air at atmospheric pressure with conventional equipment using a high frequency, high voltage generator, preferably having a power output of from 1 to 20 kw at a potential of 1 to 100 kv. Discharge is conventionally accomplished by passing the film over a dielectric support roller at the discharge station at a linear speed preferably of 1.0 to 500 m per minute. The discharge electrodes may be positioned 0.1 to 10.0 mm from the moving film surface.

The transfer-assist coating layer is preferably oriented in one or both directions of the machine and/or transverse directions of the coated film. The transfer-assist coating may be uniaxially or biaxially oriented, and is preferably biaxially oriented. Where the coated film is manufactured by coating the substrate prior to heat-setting, orientation is determined by the stretching steps used in the manufacture of the coated substrate and the heat-setting temperature used in the manufacture of the coated film is preferably selected so as to preserve the orientation induced in the preceding stretching steps.

The Transfer Layer

The composite film described herein can be used as a support in a donor element to pattern one or more materials on a receiver element with high precision and accuracy using fewer processing steps than for photolithography-based patterning techniques, and thus can be especially useful in applications such as display manufacture. The material(s) may be disposed in one or more layers with or without a binder, and are selectively transferable in entirety or in portions upon exposure to imaging radiation. Components of the transfer layer in a single portion may be selectively transferred while other components are retained. Transfer layers include those suitable for formation of colour filters, black matrix, spacers, barriers, partitions, polarizers, retardation layers, wave plates, organic conductors or semi-conductors, inorganic conductors or semi-conductors, organic electroluminescent layers, phosphor layers, organic electroluminescent devices, organic transistors, and other such elements, devices, or portions thereof that can be useful in displays, alone or in combination with other elements that may or may not be patterned in a like manner.

Suitable materials for use as a transfer layer to be deposited image-wise on a receptor element are well known in the art. The transfer layer can include organic, inorganic, organometallic, or polymeric materials. Examples of materials that can be selectively patterned from donor elements as transfer layers and/or as materials incorporated in transfer layers include colourants (including pigments and/or dyes dispersed in a binder), polarizers, liquid crystal materials, particles (including spacers for liquid crystal displays, magnetic particles, insulating particles and conductive particles), emissive materials (including phosphors and/or organic electroluminescent materials), non-emissive materials that may be incorporated into an emissive device (for example, an electroluminescent device), hydrophobic materials (including partition banks for ink jet receptors), hydrophilic materials, multilayer stacks (e.g., multilayer device constructions such as organic electroluminescent devices), micro-structured or nano-structured layers, photoresist, metals, polymers, adhesives, binders, and bio-materials, and other suitable materials or combination of materials. In one embodiment, the transfer layer includes one or more material(s) useful in display applications, particularly in the preparation of a colour filter.

In one embodiment, the transfer layer includes one or more colourant(s), such as pigment(s) and/or dye(s). Suitable materials and inks for the transfer layers to be deposited on the receptor element are well-known in the art and may comprise any colour material which can be deposited with adherence to the receptor support. In one embodiment, pigments having good colour permanency and transparency such as those disclosed in the NPIRI Raw Materials Data Handbook, Volume 4 (Pigments), are used. Examples of suitable transparent colourants include Ciba-Geigy Cromophtal Red A2B®, Dainich-Seika ECY-204®, Zeneca Monastral Green 6Y-CL®, and BASF Heliogen Blue L6700®. Other suitable transparent colourants include Sun RS Magenta 234-007®, Hoechst GS Yellow GG 11-1200®, Sun GS Cyan 249-0592®, Sun RS Cyan 248-061, Ciba-Geigy BS Magenta RT-333D®, Ciba-Geigy Microlith Yellow 3G-WA®, Ciba-Geigy Microlith Yellow 2R-WA®, Ciba-Geigy Microlith Blue YG-WA®, Ciba-Geigy Microlith Black C-WA®, Ciba-Geigy Microlith Violet RL-WA®, Ciba-Geigy Microlith Red RBS-WA®, any of the Heucotech Aquis II® series, any of the Heucosperse Aquis III series, and the like. Another class of pigments than can be used as colourants are latent pigments such as those available from Ciba-Geigy. The colours of the transfer layer may be selected as needed by the user as appropriate. When pigments are used as the colourant, they are preferably transparent. The materials may be transmissive of specific wavelengths when transferred to the receptor element. Some applications utilise highly transmissive dyes, e.g., dyes having an optical density of less than 0.5 optical density units within a narrow wavelength distribution of 10 nanometers or less. Transfer of colourants by thermal imaging is disclosed in U.S. Pat. Nos. 5,521,035; 5,695,907; and 5,863,860.

In a further embodiment, the transfer layer includes one or more material(s) useful in emissive displays such as organic electroluminescent displays and devices, or phosphor-based displays and devices. For example, the transfer layer can include a cross-linked light emitting polymer or a cross-linked charge transport material, as well as other organic conductive or semiconductive materials, whether cross-linked or not. For polymeric OLEDs, it may be desirable to cross-link one or more of the organic layers to enhance the stability of the final OLED device. Cross-linking one or more organic layers for an OLED device prior to thermal transfer may also be desired. Cross-linking before transfer can provide more stable donor media, better control over film morphology that might lead to better transfer and/or better performance properties in the OLED device, and/or allow for the construction of unique OLED devices and/or OLED devices that might be more easily prepared when crosslinking in the device layer(s) is performed prior to thermal transfer. Examples of light emitting polymers include poly(phenylenevinylene)s (PPVs), poly-para-phenylenes (PPPs), and polyfluorenes (PFs). Specific examples of cross-linkable light emitting materials that can be useful in transfer layers of the present invention include the blue light emitting poly(methacrylate) copolymers disclosed in Li et al., Synthetic Metals 84, pp. 437-438 (1997), the crosslinkable triphenylamine derivatives (TPAs) disclosed in Chen et al., Synthetic Metals 107, pp. 203-207 (1999), the crosslinkable oligo- and poly(dialkylfluorene)s disclosed in Klarner et al., Chem. Mat. 11, pp. 1800-1805 (1999), the partially crosslinked poly(N-vinylcarbazole- vinylalcohol) copolymers disclosed in Farah and Pietro, Polymer Bulletin 43, pp. 135-142 (1999), and the oxygen-crosslinked polysilanes disclosed in Hiraoka et al., Polymers for Advanced Technologies 8, pp. 465-470 (1997). Specific examples of cross-linkable transport layer materials for OLED devices that can be useful in transfer layers of the present invention include the silane functionalized triarylamine, the poly(norbomenes) with pendant triarylamine as disclosed in Bellmann et al., Chem Mater 10, pp. 1668-1678 (1998), bis-functionalized hole transporting triarylamine as disclosed in Bayerl et al., Macromol. Rapid Commun. 20, pp. 224-228 (1999), the various crosslinked conductive polyanilines and other polymers as disclosed in U.S. Pat. No. 6,030,550, the crosslinkable polyarylpolyamines disclosed in International Publication WO 97/33193, and the crosslinkable triphenyl amine-containing polyether ketone as disclosed in Japanese Unexamined Patent Publication Hei 9-255774. Light emitting, charge transport, or charge injection materials used in transfer layers of the present invention may also have dopants incorporated therein either prior to or after thermal transfer. Dopants may be incorporated in materials for OLEDs to alter or enhance light emission properties, charge transport properties and/or other such properties. Thermal transfer of materials from donor sheets to receptors for emissive display and device applications is disclosed in U.S. Pat. Nos. 5, 998,085 and 6,114,088, and in WO-00/41893-A.

Typically, the transfer layer comprises a suitable binder system and may also comprise a minor amount of radiation absorber, and/or surfactant(s) (including silicone surfactants and fluorosurfactants) or other additives. Other optional additives include dispersing agents, UV-stabilizers, plasticizers, cross-linking agents, coating aids and adhesives. Where the transfer layer comprises a radiation-absorbing compound, the compound is preferably present in an amount from about 0.5% to about to about 5% by weight of the solids fraction, preferably about 1.5% to about 3% by weight. The radiation-absorbing compound may be the same as or different to the radiation-absorbing compound in the transfer-assist layer.

The binder should not self-oxidize, decompose or degrade at the temperatures achieved during processing. Examples of suitable binders include styrene polymers and copolymers, including copolymers of styrene and (meth)acrylate esters and acids, such as styrene/methyl-methacrylate and styrene/methyl-methacrylate/acrylic-acid, copolymers of styrene and olefin monomers, such as styrene/ethylene/butylene, and copolymers of styrene and acrylonitrile; fluoropolymers; polymers and copolymers of (meth)acrylic acid and the corresponding esters, including those with ethylene and carbon monoxide; polycarbonates; polysulphones; polyurethanes; polyethers; and polyesters. The monomers for the above polymers can be substituted or unsubstituted. Mixtures of polymers can also be used. Other suitable binders include vinyl chloride polymers, vinyl acetate polymers, vinyl chloride-vinyl acetate copolymers, vinyl acetate- crotonic acid copolymers, styrene maleic anhydride half ester resins, (meth)acrylate polymers and copolymers, poly(vinyl acetals), poly(vinyl acetals) modified with anhydrides and amines, hydroxy alkyl cellulose resins and styrene acrylic resins.

The transfer layer can be coated onto the transfer-assist layer, or other suitable adjacent layer as described herein, according to conventional techniques including bar coating, gravure coating, extrusion coating, vapor deposition, lamination and other such techniques. Aqueous or non-aqueous dispersions may be used for application of the transfer layer. Prior to, after or simultaneous with coating, a cross-linkable transfer layer material or portions thereof may be cross-linked, for example by heating, exposure to radiation, and/or exposure to a chemical curative, depending upon the material.

Prior to deposition of the transfer layer onto the donor support, the exposed surface thereof may, if desired, be subjected to a chemical or physical surface-modifying treatment to improve the bond between that surface and the subsequently applied transfer layer composition, as described herein above. Such techniques may be important in situations where the exposed surface of the donor support (typically the transfer-assist layer) has a low surface energy. Such techniques may be used alone or in conjunction with surfactants such as silicone and fluorosurfactants to assist the wetting of the transfer layer onto the surface of the donor support (typically the transfer-assist layer).

Optional Intermediate Layer

An optional interlayer may be disposed in the composite film, and typically between the transfer assist coating and the transfer layer. In one embodiment, there is no interlayer present. The inclusion of an interlayer can minimise damage, contamination and/or distortion of the transferred portion of the transfer layer, and therefore of the resultant transferred image. The interlayer may also influence the adhesion of the transfer layer to the donor support. The interlayer is typically not substantially transferred with the transfer layer and should remain substantially intact during the imaging process. The interlayer should have high thermal resistance and preferably should not visibly distort or chemically decompose at temperatures below 150° C. The interlayer may comprise a film-forming organic and/or inorganic material and its identity will depend on the identity of the transfer layer and the transfer-assist coating layer. Examples of interlayers have been disclosed in U.S. Pat. No. 5,725,989 and U.S. Pat. No. 6,099,994, and include polymeric film (thermoplastic or thermoset layers), metal layers (e.g., vapour-deposited metal layers), inorganic layers (e.g., sol-gel deposited layers, vapour-deposited layers of inorganic oxides [such as silica, titania, etc., including metal oxides]), and organic/inorganic composite layers (thermoplastic or thermoset layers). The interlayer may be transmissive, absorbing or reflective, or combination thereof at the imaging radiation wavelength(s). A reflective interlayer can be used to attenuate the level of imaging radiation transmitted through the interlayer and reduce any damage to the transferred portion of the transfer layer that may result from interaction of the transmitted radiation with the transfer layer and/or the receptor. This may be particularly beneficial in reducing thermal damage which may occur when the receiver element is highly absorptive of the imaging light. Optionally, a reflective interlayer may be overcoated with a non-pigmented polymeric interlayer to allow a better release of colour image. The surface characteristics of an interlayer will depend on the application for which the imaged article is to be used. Typically, it will be desirable to have an interlayer with a smooth surface so as not to impart adverse texture to the surface of the thermally transferred layer. This is especially important for applications requiring rigid dimensional tolerances such as for colour filter elements for liquid crystal displays. However, for other applications surface roughness or relief may be tolerable or even desirable.

Optional Humectant Layer

In one embodiment, one or more humectant(s) may be included in a layer separate to the transfer-assist coating layer. In this embodiment, a humectant layer may be disposed between the polymeric substrate and the transfer-assist coating, or between the transfer-assist coating and the transfer layer. In this embodiment, the humectants and binders recited hereinabove may be suitable for the composition of such a layer, which may be coated using conventional techniques, such as those referred to herein. The thickness of a separate humectant layer depends on the amount of humectant incorporated therein, but is typically less than about 5 μm in thickness, more typically less than about 1 μm.

The Thermal Transfer Process

The thermal transfer process is one which is well-known in the art and involves the juxtaposition of the transfer layer of the donor element with the receiving surface of the receptor element, as shown in FIGS. 1 and 2. Selective exposure of the donor element to radiation, typically from a laser source, induces pattern-wise thermal transfer of the transfer material(s) in the transfer layer to the surface of the receptor element. A series of exposure steps can be effected if it is desired to transfer a plurality of transfer materials. U.S. Pat. No. 6,645,681, the disclosure of which is incorporated herein by reference, describes the use of laser-induced thermal transfer process in which the equipment comprises an imaging laser and a non-imaging laser wherein the non-imaging laser has a light detector that is in communication with the imaging laser, and wherein an additive in the donor element assists in the focussing of the imaging laser in order to expose the donor element to an amount of light sufficient for the thermal transfer of the image.

In the preparation of a colour filter, the support for the receptor element is typically glass, and relatively rigid, although flexible polymeric supports may also be used. The receptor support may be treated with an additional receiving layer or adhesion-promoting layer to promote the transfer of the imaged material(s). In the case of colour filters, the transferred imaged on the receptor element is the colour filter which is then associated with other components of a liquid crystal display. The transferred image on the receptor element may be further coated with a planarising layer. In the construction of an LCD device, a coating of a conductive layer (typically indium tin oxide (ITO)) is then applied, which may be patterned. Normally an alignment layer (typically a polyamide) is applied to the conductive layer and patterned to control the alignment of the liquid crystal material in the functioning display. The electrical addressing of a liquid crystal element overlying the patterns of images of the colour filter controls the optical transmission of the LCD device to provide a visual signal.

As described herein above, the thermal transfer process should exhibit the following characteristics:

(i) The transfer efficiency should be high, and preferably at least 85%, and more preferably 90 to 100% of material should be transferred from the donor element to the receptor element. In addition, in the preparation of colour filters involving a plurality of transferred materials which absorb visible light at different wavelengths, the fidelity of the transfer should be high, i.e. the visible transmission spectrum of the image should not substantially change before and after thermal transfer.

(ii) The resolution of the transferred image should be high with good line edge quality.

(iii) In many applications, for instance in the preparation of colour filters, the transferred image should exhibit high smoothness or planarity on the receptor.

(iv) The transfer efficiency and fidelity of transfer should be relatively independent of the power of the radiation used to effect the thermal transfer (for instance at different power levels of the irradiating laser), and this factor is typically referred to as “power latitude”. A transfer-assist layer having good power latitude shows little variation in the transfer parameters with variation in the power of irradiation.

While the present invention has been described primarily in terms of the preparation of colour filters, it will be appreciated that the aqueous coating composition and coating method described herein can be used for the provision of radiation-absorbing coatings in a variety of end uses, such as those described hereinabove. Conventional thermal transfer processes typically involve the transfer of material from a donor element to a receptor substrate to form desirable pattern(s) on a receptor substrate which is then used in the intended end-application, the donor element then being discarded. This process is the process which is typically used to manufacture articles such as colour filters suitable for use in the applications referred to herein. However, the thermal transfer of material from a donor element to a receptor substrate can also be used to image the donor element, which is then itself put to use in the end-application, the receptor substrate and the thermally-transferred material then being discarded. The present invention encompasses both such thermal transfer processes. Further applications for the present invention include the transfer or patterned removal of hydrophobic layers onto or from hydrophilic layers, or vice versa, for instance in the preparation of lithographic printing plates.

The following test methods may be used to characterise the polymeric film:

(i) Wide angle haze is measured using a Hazegard System XL-211, according to ASTM D 1003-61.

(ii) Radiation absorption and transmission (%) may be measured at the desired wavelength using a calibrated instrument operable over a wavelength range covering the desired wavelength(s). Radiation absorption and transmission (%) were measured using a Genesys 20 Spectrophotometer (ThermoSpectronic, Cambridge, UK) calibrated to ISO9001 certification standards, on a film sample of dimensions 2.75×1.875 inches at the desired wavelength. A baseline reading is first obtained as a reference by taking a reading without a sample. For the avoidance of doubt, radiation transmission of the transfer-assist layer is measured after the transfer-assist layer has been coated onto a polymeric substrate, and so the measured transmission value of the transfer-assist layer and substrate composite film requires adjustment or calibration to take into account any absorption by the polymeric substrate, and this may be effected in accordance with standard analytical methods by measuring the transmission of the uncoated substrate.

(iii) Optical density (OD) may be measured by ASTM E97 (densitometer).

(iv) Transfer efficiency in the preparation of colour filters is conveniently measured by measuring the CIE transmission colour spectrum (for instance using an Ocean Optics diode spectrophotometer) of the donor element before and after transfer, typically only over discrete regions of the spectrum, and taking a ratio of the measured transmission parameters.

(v) The line edge quality of the transferred image is typically measured by computer scanning an edge in an image and measuring the distance along the edge between two points to produce two values, L2 and L 1, L 1 being between the distance prior to image transfer, and L2 being the distance after image transfer, an L2/L1 of 1.0 representing a perfect edge.

(vi) Surface Resistivity is measured using BS2782 (Method 231a; Surface Resistivity; 1991; measuring potential: 500V). The temperature of the measurement can be varied, and in this work the temperature was 22° C., and the relative humidity was 35% or 50%.

(vii) Viscosity may be measured using ASTM D4300.

(viii) The water-absorbing properties of the humectant may be measured using a modified ASTM D750 procedure wherein an immersion tank is replaced with a humidity chamber. A known weight of humectant is placed in the humidity chamber at 27° and 90% relative humidity. The sample is weighed at regular intervals until the sample weight remains constant. The percentage increase in weight is then calculated.

(ix) The surface roughness of the pixels of the transferred image may be measured with a Tencor P-15 Stylus Profilometer, the roughness values being reported as Rq in nm. Rq (the Root Mean Square Roughness) is an averaged parameter and is defined as the root mean square average of the measured height deviations within the evaluation area and measured from the mean surface. In one embodiment, the surface roughness Rq is desirably less than 40 nm.

The invention is illustrated by reference to FIG. 1 which shows a polymeric donor element comprising a transfer layer (3), a transfer-assist layer (2) and a substrate (1), said donor element being in contact with a glass receptor element (4), and being exposed to radiation (as signified by the arrows) during a (direct) thermal imaging process. FIG. 2corresponds to FIG. 1 except that the thermal transfer is effected via gap transfer, and the donor and receptor elements are separated by a black matrix (5). The invention is further illustrated by the following examples. It will be appreciated that the examples are for illustrative purposes only and are not intended to limit the invention as described above. Modification of detail may be made without departing from the scope of the invention.

### EXAMPLES

A polymer composition, for use in the substrate layer, was prepared which comprised unfilled polyethylene terephthalate comprising either Disperse Blue 60 or Solvent Green 28 dye to give a final dye concentration of typically 0.2% to 0.5% by weight in the polymer of the substrate layer. The polymer composition containing the Disperse Blue 60 dye (0.26% by weight) had an optical density (OD) of 0.6±0.1 at 670 nm, and an OD of <0.08 at 830 nm. The polymer composition containing the Solvent Green 28 dye (0.40% by weight) had an OD of 1.2 at 670 nm, and an OD of <0.08 at 830 nm.

Coating compositions comprising one or more of the following ingredients were prepared:

(i) A 46% solids aqueous dispersion of a copolymer of ethyl acrylate (EA; 48 mole %), methyl methacrylate (MMA; 48 mole %) and methacrylamide (MA; 4 mole %) (derived from AC201®; Rohm and Haas)

(ii) TegoWet™251(4), a polyether modified polysiloxane copolymer (Goldschmidt)

(iii) Cyastat™ SP, a stearamido propyldimethyl-beta-hydroxyethyl-ammonium-dihydrogen-phosphate (Cytec)

(iv) Ammonium Hydroxide, 3%

(v) Carbon Black Waterbome Acrylic Paste 30 B111 (Penn Colour)

(vi) SDA4927, a near-infrared absorbing dye (H. W. Sands)

(vii) Distilled Water.

The coating compositions shown in Tables 1A and 1B were prepared using the amounts of ingredients (weight in grams) described therein. Ingredients (i), (ii), and (iii) were added to water with stirring. pH was adjusted with ingredient (iv) to 9.0+/−0.1, and ingredient (v) or (vi) was added with stirring. In formulations A and B, pH was not adjusted. In these formulations, the acrylic component (i) functions as the binder; component (iii) functions as a humectant; and components (v) or (vi) functions as an IR-absorber.

TABLE 1A

| INGREDIENT | FORMULATION | | | | |
|---|---|---|---|---|---|
| (weight in grams) | A | B | C | D | E |
| (i) AC201E [46%] | 1364 | 1364 | 1364 | 552.5 | 552.5 |
| (ii) TegoWet 251 (4) | 10 | 10 | 10 | 2.5 | 2.5 |
| [100%] | | | | | |
| (iii) Cyastat SP [35%] | 0 | 179.3 | 179.3 | 0 | 0 |
| (v) Carbon Black (30B111) | 0 | 0 | 1814 | 0 | 0 |
| [25.7%] | | | | | |
| (vi) SDA4927 powder | 0 | 0 | 0 | 35.62 | 35.62 |
| (vii) Water | 5000 | 5448 | 8290 | 2350 | 3905 |

TABLE 1B

| INGREDIENT | FORMULATION | | | | |
|---|---|---|---|---|---|
| (weight in grams) | F | G | H | J | K |
| (i) AC201E [46%] | 1364 | 552.5 | 552.5 | 552.5 | 552.5 |
| (ii) TegoWet 251 (4) | 10 | 2.5 | 2.5 | 2.5 | 2.5 |
| [100%] | | | | | |
| (iii) Cyastat SP [35%] | 0 | 72.6 | 72.6 | 72.6 | 72.6 |
| (v) Carbon Black | 1814 | 0 | 0 | 0 | 0 |
| (30B111) [25.7%] | | | | | |
| (vi) SDA4927 powder | 0 | 66.09 | 66.09 | 173.14 | 173.14 |
| (vii) Water | 7840 | 5290 | 8280 | 14850 | 22675 |

The formulations were then poured through a No. 541 Whatman filter paper in a Buchner funnel and vacuum filtered to remove any aggregates of carbon black or undissolved dye.

The in-line coated films were prepared as follows. The polymer composition was melt-extruded, cast onto a cooled rotating drum and stretched in the direction of extrusion to approximately 3 times its original dimensions at a temperature of 75° C. The cooled stretched film was then coated on one side with the transfer-assist coating composition to give a wet coating thickness of approximately 20 to 30 μm. A direct gravure coating system was used to apply the coatings to the film web. A 60QCH gravure roll (supplied by Pamarco) rotates through the solution, taking solution onto the gravure roll surface. The gravure roll rotates in the opposite direction to the film web and applies the coating to the web at one point of contact. The coated film was passed into a stenter oven at a temperature of 100-110° C. where the film was dried and stretched in the sideways direction to approximately 3 times its original dimensions. The biaxially stretched coated film was heat-set at a temperature of about 190° C. by conventional means. The coated polyester film is then wound onto a roll. The total thickness of the final film was 50 μm; the dry thickness of the transfer-assist coating layer is given in Tables 2 to 10.

Off-line coating of the substrate is effected as follows. The polymeric substrate (prepared as described above, omitting the in-line coating step) is laid onto a mechanized rubber roller, and a wire-wound bar is laid onto the film. Coating solution is metered onto the film on the input side of the wire-wound bar using a 10 ml syringe with a “Luer-Lok” tip (Becton Dickinson, Franklin Lakes, N.J.). A 1 micron GMF-150 filter is fitted onto the syringe (Whatman, Inc., Clifton, N.J.). Solution is pushed through the filter onto the substrate. The rubber roller then begins rotating, advancing the substrate under the wire-wound bar, which meters a uniform coating onto the web. The wet coating is dried, and the coated film is recovered. Since the off-line coatings are not stretched, proportionally less NIR absorber (relative to the examples made by an in-line process) is required in the formulations to achieve a similar % transmission at the desired wavelength. Thus, in order to compare the examples made by the in-line process described above with those made by an off-line process then the amount of NIR absorber used in the off-line process is reduced, typically to between 2 and 5 times that of the corresponding in-line formulation to compensate for the absence of a sideways draw. In addition, the percentage of solids in the formulations was diluted in order to achieve a coat weight and % transmission which is comparable to the in-line coated formulations.

All formulations in Tables 1A and 1B were applied to a substrate film comprising the Disperse Blue 60 dye.

### FORMULATION I

The following coating composition was applied to the film substrate either using offset gravure in-line coating onto base film containing Solvent Green dye at 0.4% or off-line (0-rod) to the same dry coat weight (2.0 mg/dm²), and then heated to 220° C.:

(i) demineralised water: 68.04 g

(ii) dimethylaminoethanol: 1.00 g

(iii) SDA4927 (H. W. Sands, Florida, US): 2.20 g

(iv) polyester binder (Amertech Polyester Clear; American Inks and Coatings Corp; Valley Forge; Pa.): 13.00 g of a 30% aqueous solution

(v) isopropanol : 4.00 g

(vi) TegoWet™ 251(4): 1.00 g

(vii) potassium dimethylaminoethanol ethyl phosphate : 1.39 g of an 11.5% aqueous solution

(viii) crosslinker Cymel™ 350: 7.50 g of a 20% solution

(ix) ammonium p-toluene sulphonic acid: 3.00 g of a 10% aqueous solution

Ingredients (ii) and (iii) were added to the water and allowed to stir for up to 24 hours before addition of the other ingredients. There was no need to filter this formulation.

Some of the films coated as described above were tested using the crosshatch peel adhesion test (ASTM D3359 method B and DIN standard No. 53151). Coatings prepared according to formulations G and I were coated both in-line and off-line to 2 mg/dm² coating weight, and the adhesion to the polyester substrate measured. Both in-line coated formulations retained 100% of the crosshatched areas, while the off-line coated formulations retained 0% of the crosshatch areas. The in-line coated layers have significantly better adhesion to the polyester substrate, and are therefore more resistant to blocking, scratching and abrasion than the off-line coated films.

The composite films comprising the polyester substrate and transfer-assist coatings A to K were then used in the manufacture of a colour filter. The coated substrate was coated with a transfer layer formulation (referred to hereinafter as “Blue 72”) made by combining 67.4 parts blue pigment dispersion (49.3% non-volatile), 3.60 parts violet pigment dispersion (25% non-volatile), 229.2 parts water, 90.8 parts Joncryl® 63, 2.4 parts aqueous ammonium hydroxide (3%), 1.4 parts Zonyl®FSA, 1.20 parts SDA-4927, and 4 parts Aerotex 3730, to form a donor element. The donor element was then juxtaposed with a receptor element (a glass colour filter substrate having previously transferred colour pixels), such that the layer was substrate/transfer assist layer/transfer layer/pixels/glass, to form an imageable assemblage. The imageable assemblage was imaged using a rapidly moving, blinking 830 nm laser impinging on the substrate at a fluence of approximately 400 mJ/cm² and exposure time of less than 5 μs to transfer blue pixels.

The thermal transfer process and the quality of the colour filters were assessed by measuring x, y and Y values for colour coordinates in the CIE system in which x and y describe the hue of a colour, and Y is a measure of the luminance (ratio of transmitted photons/incident photons). Tables 2 to 10 show the imaging results. The target colour specification is x=0.14 (±0.006); y=0.14 (±0.006); and Y=19.41 (±3.0), and colour coordinates falling within these ranges are marked as “in spec”. If x and y are within ±0.02 and Y is within ±6.0 from the target specification, the colour coordinates are marked as “close”, and otherwise are marked as “off spec”. The transfer efficiency was also measured. The aim is to achieve a high and consistent transfer efficiency over a range of incident laser power. This is desirable as the power output of commercial lasers is prone to drift in practice. The preferred embodiment, which comprises use of a near-IR absorber and humectant, provides the most balanced properties in terms of transfer efficiency and colour values, and in this embodiment the transfer efficiency is lifted to above 80% at almost all power levels with colour values in or near the target specification.

### FORMULATION L

A coating formulation similar to that of Formulation I was made up as follows:

(i) demineralised water: 894 g;

(ii) dimethylaminoethanol : 5 g;

(iii) Hampford dye 822 (Hampford Research; formulation corresponds to SDA4927): 10 g;

(iv) polyester binder (Amertech Polyester Clear; American Inks and Coatings Corp; Valley Forge; Pa.): 65 g of a 30% aqueous solution

(v) TegoWet™ 251(4): 2.5 g

(vi) potassium dimethylaminoethanol ethyl phosphate: 14 g of an 11.5% aqueous solution;

(vii) crosslinker Cymel™ 350: 10 g of a 20% solution;

(viii) ammonium p-toluene sulphonic acid: 2 g of a 10% aqueous solution.

Ingredients (ii) and (iii) were added to the water and allowed to stir for up to 24 hours before addition of the other ingredients in the order shown. There was no need to filter this formulation. Formulation L was applied in an in-line coating technique to a film substrate as described for Formulation I, to give a final dry coat weight of 0.07 μm.

### FORMULATION M

A coating formulation was made up as follows:

(i) demineralised water: 800 g

(ii) dimethylaminoethanol : 5 g

(iii) Hampford dye 822 (Hampford Research; formulation corresponds to SDA4927): 10 g

(iv) SMA1440H binder (esterified styrene maleic anhydride copolymer; Cray Valley Photocure, France): 86 g of a 34% aqueous solution

(v) TegoWet™ 251(4): 2.5 g

(vi) potassium dimethylaminoethanol ethyl phosphate: 14 g of an 11.5% aqueous solution

(vii) crosslinker Cymel™ 350: 17 g of a 20% solution

(viii) ammonium p-toluene sulphonic acid: 3 g of a 10% aqueous solution

Ingredients (ii) and (iii) were added to the water and allowed to stir for up to 24 hours before addition of the other ingredients in the order shown. There was no need to filter this formulation. Formulation M was applied to a film substrate as described for Formulation L to give a final dry coat weight of 0.10 μm.

The composite films comprising the polyester substrate and transfer-assist coatings L and M were then used in the manufacture of a colour filter. The coated substrate was coated with a red transfer layer formulation prepared by adding the following ingredients in the order listed into a beaker and stirring for 3 hours:

| | |
|---|---|
| (i) demineralised water | 245.146 |
| (ii) Carboset GA2300 (Noveon Inc. Cleveland Ohio) | 108.932 |
| (iii) Carboset xpd2091 (Noveon Inc. Cleveland Ohio) | 7.865 |
| (iv) NH₄OH (3% aq. solution) | 2.496 |
| (v) Red 254 pigment dispersion (Penn Colour Inc, Doylestown, | 218.4 |
| PA) | |
| (vi) Yellow 83 pigment dispersion (Penn Colour Inc, | 5.117 |
| Doylestown, PA) | |
| (vii) Zonyl ® FSA (DuPont, Wilmington, DE) | 2.496 |
| (viii) SDA-4927 (H W Sands) | 1.435 |
| (ix) Cross-linker | 7.488 |
| (x) Surfynol DF110D (Air Products Chemicals, Allentown, PA) | 0.624 |

After drying, the red transfer layer had a dried coating weight of 40.0 mg/sqdm. This forms a red donor element. A section of the red donor element was then juxtaposed with a receptor element (a glass colour filter substrate having previously transferred colour pixels) such that the red coating is in contact with the imaged pixels to form an imageable assemblage. The imageable assemblage was imaged using a rapidly moving 830 nm laser impinging on the substrate at a fluence of approximately 400 mJ/cm² and exposure time of less than 5 μs to transfer red pixels. The red donor element is then removed, and the imaged colour filter baked at 230° C. for 1 hour to solidify the transferred colour pixels. The annealed filter was examined with a microscope at 200× total magnifying power, and the line-widths of the annealed red lines measured at a range of incident laser powers, along with the surface roughness. A line-width of at least 85 μm is desirable. The thermal transfer process and the quality of the colour filters were assessed by measuring x, y and Y values for colour coordinates in the CIE system in which x and y describe the hue of a colour, and Y is a measure of the luminance (ratio of transmitted photons/incident photons). The target colour specification is x=0.6504 (±0.0085); y=0.3346 (±0.0085); and Y=20 (±3.0), and colour coordinates falling within these ranges are marked as “in spec”. If x and y are within ±0.02 and Y is within ±6.0 from the target specification, the colour coordinates are marked as “close”, and otherwise are marked as “off spec”. Table 11 shows the imaging results.

TABLE 2

| Transfer assist layer | | | Image transfer layer (donor) | | Imaging | | | | |
|---|---|---|---|---|---|---|---|---|---|
| | Thickness | % transmission | | Coat weight | Laser power | x | y | Y | % |
| Formulation | (μm) | @ 830 nm | Formulation | (mg/dm²) | (watts) | value | value | value | transfer |
| A: | 0.33 | 90 | Blue 72 | 15 | 14 | off spec | off spec | off spec | 71.89 |
| binder only | | | | | 17 | off spec | off spec | off spec | 82.94 |
| | | | | | 21.5 | off spec | off spec | close | 65.66 |
| B: | 0.36 | 90 | Blue 72 | 15 | 14 | off spec | off spec | off spec | 59.03 |
| binder & | | | | | 17 | off spec | off spec | off spec | 62.35 |
| humectant | | | | | 21.5 | off spec | off spec | off spec | 68.73 |

TABLE 3

| Transfer assist layer | | | Image transfer layer (donor) | | Imaging | | | | |
|---|---|---|---|---|---|---|---|---|---|
| | Thickness | % transmission | | Coat weight | Laser power | x | y | Y | % |
| Formulation | (μm) | @ 830 nm | Formulation | (mg/dm²) | (watts) | value | value | value | transfer |
| D: | 0.28 | 34 | Blue 72 | 15 | 14 | close | close | in spec | 92.14 |
| binder & | | | | | 17 | close | off spec | in spec | 87.26 |
| absorber | | | | | 21.5 | close | close | in spec | 79.56 |
| E: | 0.21 | 44 | Blue 72 | 15 | 14 | close | close | in spec | 87.85 |
| binder & | | | | | 17 | close | off spec | in spec | 83.26 |
| absorber | | | | | 21.5 | close | close | in spec | 84.58 |
| F: | 0.33 | 52 | Blue 72 | 15 | 14 | close | close | in spec | 80.66 |
| binder & | | | | | 17 | close | close | in spec | 87.07 |
| absorber | | | | | 21.5 | close | close | in spec | 92.56 |

TABLE 4

| | | |
|---|---|---|
| Transfer assist layer | Image transfer layer (donor) | Imaging |

| | Thickness | % transmission | | Coat weight | Laser power | x | y | Y | % |
|---|---|---|---|---|---|---|---|---|---|
| Formulation | (μm) | @ 830 nm | Formulation | (mg/dm²) | (watts) | value | value | value | transfer |
| G: | 0.16 | 40 | Blue 72 | 15 | 14 | close | close | in spec | 98.33 |
| binder; humectant; & | | | | | 17 | close | close | in spec | 94.45 |
| absorber | | | | | 21.5 | close | close | in spec | 90.11 |
| H: | 0.18 | 46 | Blue 72 | 15 | 14 | close | off spec | in spec | 79.32 |
| binder; humectant; & | | | | | 17 | close | close | in spec | 92.50 |
| absorber | | | | | 21.5 | close | off spec | in spec | 92.61 |
| J: | 0.11 | 45 | Blue72 | 15 | 14 | close | off spec | in spec | 85.59 |
| binder; humectant; & | | | | | 17 | close | off spec | in spec | 87.74 |
| absorber | | | | | 21.5 | close | off spec | in spec | 88.63 |
| K: | 0.07 | 50 | Blue 72 | 15 | 14 | close | off spec | in spec | 82.5 |
| binder; humectant; & | | | | | 17 | close | off spec | in spec | 83.3 |
| absorber | | | | | 21.5 | close | off spec | close | 79.3 |

The data in Table 4 (compared with those of table 3) show that the humectant improves the transfer process by reducing the variability of transfer efficiency with laser power and in many cases achieves greater than 90% with 40-50% transmission at 830 nm. Improved efficiency is achieved when the thickness of the transfer-assist layer is above 0.15 μm.

TABLE 5

| Transfer assist layer | | | Image transfer layer (donor) | | Imaging | | | | |
|---|---|---|---|---|---|---|---|---|---|
| | Thickness | % transmission | | Coat weight | Laser power | x | y | Y | % |
| Formulation | (μm) | @ 830 nm | Formulation | (mg/dm²) | (watts) | value | value | value | transfer |
| C: | 0.28 | 54 | Blue 72 | 15 | 14 | close | close | in spec | 83.52 |
| binder; | | | | | 17 | close | close | in spec | 83.70 |
| humectant & | | | | | 21.5 | close | close | in spec | 93.27 |
| carbon black | | | | | | | | | |

TABLE 6

| Transfer assist layer | | | | Image transfer layer (donor) | | Imaging | | | | |
|---|---|---|---|---|---|---|---|---|---|---|
| | Off-line/ | Thickness | % transmission | | Coat weight | Laser power | x | y | Y | % |
| Formulation | In-line | (μm) | @ 830 nm | Formulation | (mg/dm²) | (watts) | value | value | value | transfer |
| E: | In-line | 0.21 | 48.6 | Blue 72 | 15 | 14 | close | close | in spec | 87.8 |
| binder | | | | | 17 | | close | off spec | in spec | 83.3 |
| & absorber | | | | | 21.5 | | close | close | in spec | 84.6 |
| E: | Off-line | 0.20 | 51.7 | Blue 72 | 15 | 14 | off spec | off spec | close | 84.3 |
| binder | | | | | 17 | | off spec | off spec | off spec | 85.9 |
| & absorber | | | | | 20 | | off spec | off spec | off spec | 71.2 |

The data in Table 6 compare in-line and off-line coated films. At 50% transmission, in-line coated films give higher % transfer and improved colour rendition.

TABLE 7

| Transfer assist layer | | | | Image transfer layer (donor) | | Imaging | | | | |
|---|---|---|---|---|---|---|---|---|---|---|
| | Off-line/ | Thickness | % transmission | | Coat weight | Laser power | x | y | Y | % |
| Formulation | In-line | (μm) | @ 830 nm | Formulation | (mg/dm²) | (watts) | value | value | value | transfer |
| F: | In-line | 0.33 | 53.5 | Blue 72 | 15 | 14 | close | close | In spec | 80.7 |
| binder; | | | | | 17 | | close | close | In spec | 87.1 |
| carbon black | | | | | 21.5 | | close | close | In spec | 92.6 |
| F: | Off-line | 0.31 | 54.7 | Blue 72 | 15 | 14 | off spec | off spec | close | 80.4 |
| binder; | | | | | 17 | | close | close | In spec | 78.3 |
| carbon black | | | | | | 20 | close | off spec | In spec | 94.5 |

TABLE 8

| Transfer assist layer | | | | Image transfer layer (donor) | | Imaging | | | | |
|---|---|---|---|---|---|---|---|---|---|---|
| | Off-line/ | Thickness | % transmission | | Coat weight | Laser power | x | y | Y | % |
| Formulation | In-line | (μm) | @ 830 nm | Formulation | (mg/dm²) | (watts) | value | value | value | transfer |
| C: | In-line | 0.28 | 52 | Blue 72 | 15 | 14 | close | close | in spec | 83.5 |
| binder, | | | | | | 17 | close | close | in spec | 83.7 |
| humectant, | | | | | | 21.5 | close | close | in spec | 93.3 |
| & carbon black | | | | | | | | | | |
| C: | Off-line | 0.28 | 54 | Blue 72 | 15 | 14 | close | off spec | in spec | 87.4 |
| binder, | | | | | | 17 | close | off spec | in spec | 80.0 |
| humectant, | | | | | | 20 | close | off spec | in spec | 94.7 |
| & carbon black | | | | | | | | | | |

TABLE 9

| Transfer assist layer | | | | Image transfer layer (donor) | | Imaging | | | | |
|---|---|---|---|---|---|---|---|---|---|---|
| | Off-line/ | Thickness | % transmission | | Coat weight | Laser power | x | y | Y | % |
| Formulation | In-line | (μm) | @ 830 nm | Formulation | (mg/dm²) | (watts) | value | value | value | transfer |
| G: binder | In-line | 0.16 | 48.6 | Blue 72 | 15 | 14 | close | close | In spec | 98.3 |
| humectant & | | | | | | 17 | close | close | In spec | 94.5 |
| absorber | | | | | | 21.5 | close | close | In spec | 90.1 |
| G: binder | Off-line | 0.18 | 51.7 | Blue 72 | 15 | 14 | close | off spec | In spec | 91.5 |
| humectant & | | | | | | 17 | close | off spec | close | 92.3 |
| absorber | | | | | | 20 | off spec | off spec | off spec | 90.9 |

The data in Table 9 compare in-line and off-line coated films. The in-line coated films give superior results. The data also show that the presence of humectant gives improved transfer and good colour rendition.

TABLE 10

| Transfer assist layer | | | | | | Imaging | | | | |
|---|---|---|---|---|---|---|---|---|---|---|
| | | | % | Image transfer layer (donor) | | Laser | | | | |
| | Off-line/ | thickness | transmission | | Coat Weight | power | x | y | Y | % |
| Formulation | In-line | (μm) | @ 830 nm | Formulation | (mg/dm²) | (watts) | value | value | value | transfer |
| I: | In-line | 0.21 | 36.9 | Blue 72 | 15 | 14 | close | off spec | In spec | 89.7 |
| binder, | | | | | | 17 | close | off spec | In spec | 90.9 |
| humectant & | | | | | | 18.5 | close | off spec | In spec | 91.1 |
| absorber | | | | | | 20 | close | off spec | In spec | 93.1 |
| | | | | | | 21.5 | close | off spec | In spec | 92.0 |
| | | | | | | 23 | close | off spec | close | 91.4 |

TABLE 11

| Transfer assist layer | | | Imaging | | | | | |
|---|---|---|---|---|---|---|---|---|
| | Thickness | % transmission | Laser power | x | y | Y | Linewidth | Rq |
| Formulation | (μm) | @ 830 nm | (watts) | value | value | value | (μm) | (nm) |
| L | | 48 | 23.0 | in spec | in spec | close | 101.4 | 37.4 |
| | | | 20.0 | in spec | in spec | in spec | 96.7 | 28.97 |
| | | | 18.5 | in spec | in spec | in spec | 100.1 | 14.37 |
| | | | 17.0 | in spec | in spec | in spec | 95.0 | 25.13 |
| | | | 15.5 | close | in spec | in spec | | |
| M | | 47 | 20.0 | in spec | in spec | in spec | 101.4 | 37.1 |
| | | | 18.5 | in spec | in spec | in spec | 101.1 | 11.6 |
| | | | 17.0 | in spec | in spec | in spec | 86.8 | 11.53 |
| | | | 15.5 | in spec | in spec | in spec | 90.6 | 11.23 |
| | | | 14.0 | in spec | in spec | in spec | 88.6 | 10.78 |
| | | | 12.5 | in spec | in spec | in spec | | |

Formulations L and M exhibit the target colour properties, surface roughness and line-width and these are achieved at lower applied power, and over a wider range of operating power (which is desirable as laser power can drift in practice).

1-29. (canceled)

30. A composite film suitable as a donor support in a radiation-induced thermal transfer imaging process, said film comprising a polymeric substrate and a transfer-assist coating layer derived from an aqueous composition comprising one or more water-soluble or water-dispersible radiation-absorbing compound(s).

31. The composite film according to claim 30 wherein said transfer-assist coating layer further comprises one or more water-soluble or water-dispersible polymeric binder(s).

32. The composite film according to claim 30 wherein the transfer-assist coating layer is an in-line coated layer.

33. The composite film according to claim 30 wherein the transfer-assist coating layer is uniaxially or biaxially oriented.

34. The composite film according to claim 30 further comprising one or more humectant(s).

35. The composite film according to claim 34 wherein humectant is present in the transfer-assist coating layer.

36. The composite film according to claim 35 wherein said aqueous composition comprises from about 0.05 to about 70% by weight of the solids fraction of said humectant(s).

37. The composite film according to claim 30 wherein said aqueous composition comprises from about 5 to about 85% by weight of the solids fraction of said water-soluble or water-dispersible radiation-absorbing compound(s).

38. The composite film according to claim 30 wherein said water-soluble or water-dispersible radiation-absorbing compound(s) are selected from cyanines.

39. The composite film according to claim 31 wherein said water-soluble or water-dispersible polymeric binder(s) are selected from polyesters and acrylic resins.

40. The composite film according to claim 31 wherein said water-soluble or water-dispersible polymeric binder is a nitrocellulose.

41. The composite film according to claim 31 wherein said water-soluble or water-dispersible polymeric binder is a polymethylmethacrylate.

42. The composite film according to claim 31 wherein said water-soluble or water-dispersible polymeric binder is a polyalkylenecarbonate.

43. The composite film according to claim 31 wherein said water-soluble or water-dispersible polymeric binder is a styrene maleic anhydride copolymer.

44. The composite film according to claim 31 wherein said water-soluble or water-dispersible polymeric binder is a polyvinylbutyral resin.

45. The composite film according to claim 31 wherein said transfer-assist coating layer comprises a polymer selected from the group consisting of PVOH; polyvinylpyrrolidones (PVP); polysaccharide resins; poly(ethylene oxide)s; gelatin; and hydroxyethyl cellulose.

46. The composite film according to claim 30 wherein the polymeric substrate is a polyester substrate.

47. The composite film according to claim 30 wherein the substrate is uniaxially or biaxially oriented.

48. The composite film according to claim 30 further comprising one or more light attenuating agent(s).

49. The composite film according to claim 48 wherein said light attenuating agent(s) is/are present in the substrate.

50. The composite film according to claim 48 wherein said light attenuating agent(s) is a blue phthalocyanine pigment or green anthraquinone pigment.

51. The composite film according to claim 30 wherein the substrate has a thickness of from about 12 to about 300 μm.

52. The composite film according to claim 30 wherein the transfer-assist coating has a thickness of from about 0.01 to about 1 μm.

53. The composite film according to claim 30 further comprising an antistatic layer wherein the transfer-assist coating is disposed on a first surface of the polymeric substrate and an antistatic layer is disposed on the second surface of the polymeric substrate.

54. An aqueous transfer-assist coating composition comprising one or more water-soluble or water-dispersible radiation-absorbing compound(s), and optionally one or more water-soluble or water-dispersible polymeric binder(s), and optionally one or more humectant(s).

55. A method of manufacture of a composite film suitable for use as a donor support in a radiation-induced thermal transfer imaging process, said composite film comprising a polymeric substrate and a transfer-assist coating layer, said transfer-assist coating layer comprising one or more water-soluble or water-dispersible radiation-absorbing compound(s), said process comprising the steps of:
(a) melt-extruding a substrate layer of polymeric material;
(b) stretching the substrate layer in a first direction;
(c) optionally stretching the substrate layer in a second, orthogonal direction;
(d) forming a transfer-assist coating layer by applying to a surface of the substrate an aqueous composition comprising said water-soluble or water-dispersible radiation-absorbing compound(s);
(e) optionally heat-setting the stretched film; and
(f) optionally winding the film to form a reel.

56. The method according to claim 55 wherein said aqueous composition comprises one or more water-soluble or water-dispersible polymeric binder(s).

57. The method according to claim 55 wherein said transfer-assist coating layer is coated by an in-line coating technique.

58. The method according to claim 55 wherein said composite film further comprises one or more humectant(s), optionally disposed in the transfer-assist coating layer.

59. The composite film according to claim 30 wherein said transfer-assist coating layer is disposed on the first surface of said polymeric substrate and there is disposed on the second surface of the polymeric substrate a coating comprising poly(methyl methacrylate) in particulate form.

60. The composite film according to claim 59 wherein said poly(methyl methacrylate) is in the form of particles having a diameter in the range of from about 0.1 to about 0.3 μm.

61. The method according to claim 55 wherein said transfer-assist coating layer is disposed on the first surface of said polymeric substrate and wherein said method further comprises disposing on the second surface of the polymeric substrate a coating comprising poly(methyl methacrylate) in particulate form.

62. The method according to claim 61 wherein said poly(methyl methacrylate) is in the form of particles having a diameter in the range of from about 0.1 to about 0.3 μm.
